(19) United States
(12) Patent Application Publication
(10) Pub. No.: US 2024/0284521 A1
(43) Pub. Date: Aug. 22, 2024

(54) APERIODIC RANDOM ACCESS CHANNEL PROCEDURE FOR LAYER 1/LAYER 2 TRIGGERED MOBILITY

(71) Applicant: Qualcomm Incorporated, San Diego, CA (US)

(72) Inventors: Jae Ho RYU, San Diego, CA (US); Yan ZHOU, San Diego, CA (US); Rebecca Wen-Ling YUAN, San Diego, CA (US); Changhwan PARK, San Diego, CA (US)

(21) Appl. No.: 18/442,335

(22) Filed: Feb. 15, 2024

Related U.S. Application Data
(60) Provisional application No. 63/485,607, filed on Feb. 17, 2023.

(51) Int. Cl. H04W 74/0838; H04W 36/04; H04W 74/08; H04W 80/02

(52) U.S. Cl. CPC H04W 74/0838; H04W 36/04; H04W 74/0866; H04W 80/02

(57) ABSTRACT

Various aspects of the present disclosure generally relate to wireless communication. In some aspects, a user equipment (UE) may receive, from a network node via a source cell, a medium access control (MAC) control element (MAC-CE) triggering a handover from the source cell to a target cell in an activated cell set configured for Layer 1/Layer 2 (L1/L2) mobility. The UE may transmit, to the network node via the target cell, a physical random access channel (PRACH) to initiate an aperiodic contention-free random access (CFRA) procedure in the target cell in a random access channel (RACH) occasion in a PRACH slot associated with a slot offset indication received from the network node. Numerous other aspects are described.

### CROSS-REFERENCE TO RELATED APPLICATION

This patent application claims priority to U.S. Provisional Patent Application No. 63/485,607, filed on Feb. 17, 2023, entitled “APERIODIC RANDOM ACCESS CHANNEL PROCEDURE FOR LAYER 1/LAYER 2 TRIGGERED MOBILITY,” and assigned to the assignee hereof. The disclosure of the prior Application is considered part of and is incorporated by reference into this patent application.

### FIELD OF THE DISCLOSURE

Aspects of the present disclosure generally relate to wireless communication and specifically, to techniques and apparatuses associated with an aperiodic random access channel (RACH) procedure for Layer 1/Layer 2 (L1/L2) triggered mobility (LTM).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP). As the demand for mobile broadband access continues to increase, further improvements in LTE, NR, and other radio access technologies remain useful.

As described herein, a wireless network may support Layer 1 and/or Layer 2 (L1/L2) triggered mobility (LTM) to enable fast connected mode mobility that may reduce data interruption relative to Layer 3 (L3) triggered mobility by reducing radio resource control (RRC) signaling and associated processing delays and/or by reducing downlink synchronization and/or random access channel (RACH) procedure times. For example, in L3 triggered mobility, an RRC configuration for a target cell needs to be delivered to a UE, and the UE needs to be reconfigured to communicate with the target cell based on the RRC signaling. Accordingly, one potential approach to reducing data interruption due to L3 mobility may be to provide the RRC configuration in advance, and then reduce a downlink synchronization and/or RACH procedure time. For example, in an existing L3 handover procedure, the UE may need to first establish downlink synchronization and then establish uplink synchronization on the target cell via a contention-free random access (CFRA) procedure on the target cell before access link communications can be enabled on the target cell. Although the UE can generally start the RACH procedure on the target cell as soon as the UE establishes downlink synchronization on the target cell, a delay in initiating the RACH procedure can be large, due to uncertainty regarding a next available RACH occasion in which the UE can transmit a PRACH preamble toward the target cell.

For example, existing techniques to perform a CFRA procedure to execute a handover are subject to a large delay, which is primarily caused by a large RACH resource periodicity. For example, the RACH resource periodicity in a target cell may be 10 milliseconds (ms), 20 ms, 40 ms, 80 ms, or 160 ms (e.g., a frame duration may be 10 ms, and a RACH resource may have a periodicity such that the RACH resource is available once in every 1, 2, 4, 8, or 16 frames). Accordingly, after the UE receives a handover command or a conditional handover command and performs all of the procedures leading up to the interruption uncertainty time, the UE may be ready to communicate with the target cell on a downlink but still needs to perform a RACH procedure in the target cell to enable uplink synchronization. However, at the moment that the uncertainty time begins, the next periodic RACH resource that is available may be 10 ms, 20 ms, 40 ms, 80 ms, or 160 ms away (e.g., depending on the RACH resource periodicity).

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive, from a network node via a source cell, a medium access control (MAC) control element (MAC-CE) triggering a handover from the source cell to a target cell in an activated cell set configured for Layer 1/Layer 2 (L1/L2) mobility. At least one processor of the one or more processors may be configured to cause the UE to transmit, to the network node via the target cell, a physical random access channel (PRACH) preamble to initiate an aperiodic contention-free random access (CFRA) procedure in the target cell in a random access channel (RACH) occasion in a PRACH slot associated with a slot offset indication received from the network node.

Some aspects described herein relate to an apparatus for wireless communication at a network node. The apparatus may include one or more memories and one or more processors coupled with the one or more memories. At least one processor of the one or more processors may be configured to cause the network node to transmit, to a UE via a source cell, a MAC-CE triggering a handover from the source cell to a target cell in an activated cell set configured for L1/L2 mobility. At least one processor of the one or more processors may be configured to cause the network node to receive, from the UE via the target cell, a PRACH preamble to initiate an aperiodic CFRA procedure in the target cell in a RACH occasion in a PRACH slot that is associated with a slot offset indication.

Some aspects described herein relate to a method of wireless communication performed at a UE. The method may include receiving, from a network node via a source cell, a MAC-CE triggering a handover from the source cell to a target cell in an activated cell set configured for L1/L2 mobility. The method may include transmitting, to the network node via the target cell, a PRACH preamble to initiate an aperiodic CFRA procedure in the target cell in a RACH occasion in a PRACH slot associated with a slot offset indication received from the network node.

Some aspects described herein relate to a method of wireless communication performed at a network node. The method may include transmitting, to a UE via a source cell, a MAC-CE triggering a handover from the source cell to a target cell in an activated cell set configured for L1/L2 mobility. The method may include receiving, from the UE via the target cell, a PRACH preamble to initiate an aperiodic CFRA procedure in the target cell in a RACH occasion in a PRACH slot that is associated with a slot offset indication.

Some aspects described herein relate to a non-transitory computer-readable medium that stores a set of instructions for wireless communication by a UE. The set of instructions, when executed by one or more processors of the UE, may cause the UE to receive, from a network node via a source cell, a MAC-CE triggering a handover from the source cell to a target cell in an activated cell set configured for L1/L2 mobility. The set of instructions, when executed by one or more processors of the UE, may cause the UE to transmit, to the network node via the target cell, a PRACH preamble to initiate an aperiodic CFRA procedure in the target cell in a RACH occasion in a PRACH slot associated with a slot offset indication received from the network node.

Some aspects described herein relate to a non-transitory computer-readable medium that stores a set of instructions for wireless communication by a network node. The set of instructions, when executed by one or more processors of the network node, may cause the network node to transmit, to a UE via a source cell, a MAC-CE triggering a handover from the source cell to a target cell in an activated cell set configured for L1/L2 mobility. The set of instructions, when executed by one or more processors of the network node, may cause the network node to receive, from the UE via the target cell, a PRACH preamble to initiate an aperiodic CFRA procedure in the target cell in a RACH occasion in a PRACH slot that is associated with a slot offset indication.

Some aspects described herein relate to an apparatus for wireless communication. The apparatus may include means for receiving, from a network node via a source cell, a MAC-CE triggering a handover from the source cell to a target cell in an activated cell set configured for L1/L2 mobility. The apparatus may include means for transmitting, to the network node via the target cell, a PRACH preamble to initiate an aperiodic CFRA procedure in the target cell in a RACH occasion in a PRACH slot associated with a slot offset indication received from the network node.

Some aspects described herein relate to an apparatus for wireless communication. The apparatus may include means for transmitting, to a UE via a source cell, a MAC-CE triggering a handover from the source cell to a target cell in an activated cell set configured for L1/L2 mobility. The apparatus may include means for receiving, from the UE via the target cell, a PRACH preamble to initiate an aperiodic CFRA procedure in the target cell in a RACH occasion in a PRACH slot that is associated with a slot offset indication.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples, in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example of a four-step random access channel (RACH) procedure, in accordance with the present disclosure.

FIG. 4 is a diagram illustrating an example of a make-before-break handover procedure, in accordance with the present disclosure.

FIG. 5 is a diagram illustrating an example of Layer 1/Layer 2 (L1/L2) inter-cell mobility, in accordance with the present disclosure.

FIG. 6 is a diagram illustrating examples of handover interruption, in accordance with the present disclosure.

FIGS. 7A-7B are diagrams illustrating examples associated with an aperiodic RACH procedure for L1/L2 triggered mobility (LTM), in accordance with the present disclosure.

FIGS. 8A-8B are diagrams illustrating examples associated with an aperiodic RACH procedure for LTM, in accordance with the present disclosure.

FIG. 9 is a flowchart illustrating an example process performed, for example, by a UE, in accordance with the present disclosure.

FIG. 10 is a flowchart illustrating an example process performed, for example, by a network node, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In Layer 1/Layer 2 (L1/L2) triggered mobility (LTM), a random access channel (RACH) delay may present a bottleneck for an overall LTM-based handover time. Existing RACH procedures generally provide sufficient performance for an intra-frequency LTM-based handover, but not for an inter-frequency LTM-based handover. For example, in an inter-frequency LTM-based handover scenario, a user equipment (UE) has to perform radio frequency (RF) retuning to an RF frequency of a target cell, send a PRACH preamble, and then tune back to a frequency of a source cell. This procedure is complicated for implementation and may still not reduce the overall handover time.

Various aspects relate generally to techniques to configure an aperiodic RACH resource that a UE can use to transmit a physical random access channel (PRACH) preamble to initiate a contention-free RACH (CFRA) procedure in a target cell configured for LTM. Some aspects more specifically relate to an LTM source cell preconfiguring various PRACH parameters associated with an aperiodic PRACH resource in a radio resource control (RRC) configuration prior to an LTM trigger of a handover from the LTM source cell to an LTM target cell, where the PRACH parameters may relate to a time-frequency resource, a PRACH waveform, and/or power control. Accordingly, when the LTM source cell transmits a medium access control (MAC) control element (MAC-CE) to a UE to trigger a handover from the LTM source cell to an LTM target cell, one or more PRACH parameters for transmitting a PRACH preamble to initiate a CFRA procedure in the target cell can be dynamically indicated in the MAC-CE transmitted by the LTM source cell or a physical downlink control channel (PDCCH) order that is transmitted by the LTM target cell to trigger the CFRA procedure in the target cell. For example, in some aspects, the dynamically indicated PRACH parameters may include a slot offset indication, which may have a value of zero (0) or more slots defined relative to a processing delay of the MAC-CE or relative to the PDCCH order. Accordingly, the UE may transmit the PRACH preamble toward the LTM target cell in a RACH occasion within a PRACH slot associated with the slot offset indication. Furthermore, some aspects described herein relate to techniques to enable multiple PRACH opportunities or otherwise trigger the CFRA procedure multiple times until the CFRA procedure is complete and/or to configure a transmission power of the PRACH transmission to increase a likelihood of the LTM target cell successfully detecting the PRACH preamble.

Particular aspects of the subject matter described in this disclosure can be implemented to realize one or more of the following potential advantages. In some examples, relative to relying on a periodic RACH resource to initiate the CFRA procedure in a target cell, the described techniques can be used to significantly reduce an interruption uncertainty in acquiring the first available PRACH occasion in the target cell, which reduces the latency or delay associated with when the UE can start to transmit and receive data in the target cell. Furthermore, by configuring multiple PRACH opportunities and/or initiating PDCCH orders to trigger a CFRA procedure in the target cell multiple times, some aspects described herein increase a likelihood that the CFRA procedure will be completed successfully and thereby enable the handover to the LTM target cell. Furthermore, by determining an appropriate transmission power for a PRACH transmission and/or applying power ramping to increase the PRACH transmission power over successive PRACH transmissions in successive PRACH slots, some aspects described herein increase the likelihood that the LTM target cell will detect the PRACH transmitted by the UE and successfully complete the CFRA procedure. Furthermore, because a UE performs a RACH procedure in a target cell and remains in the target cell without tuning back to a source cell frequency after receiving a handover command, the RACH latency and overall handover time may be reduced.

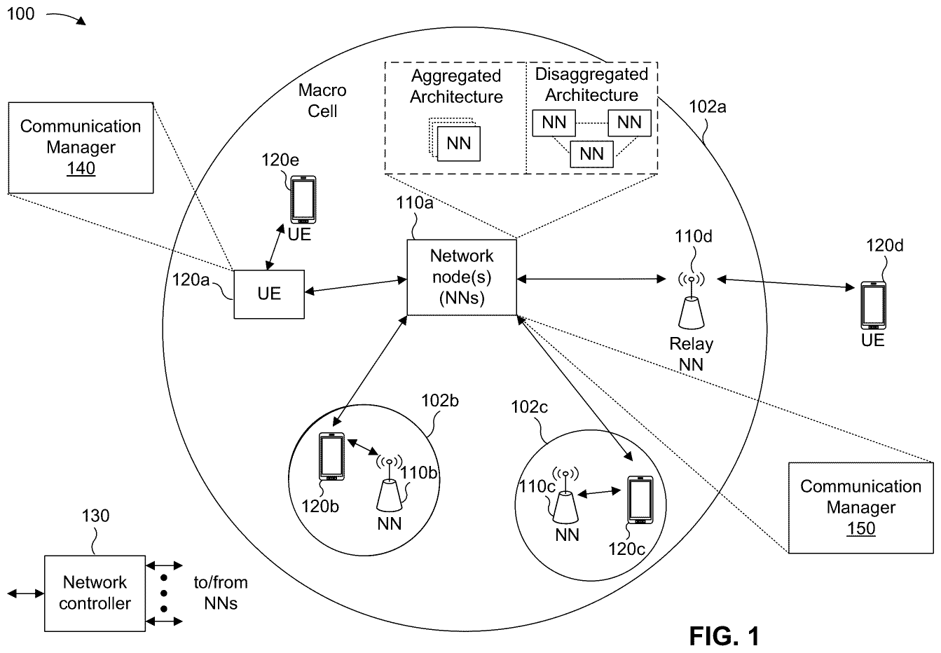

FIG. 1 is a diagram illustrating an example of a wireless network, in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move, in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node 110 via a source cell, a MAC-CE triggering a handover from the source cell to a target cell in an activated cell set configured for L1/L2 mobility; and transmit, to the network node 110 via the target cell, a PRACH preamble to initiate an aperiodic CFRA procedure in the target cell in a RACH occasion in a PRACH slot associated with a slot offset indication received from the network node. Additionally, or alternatively, the communication manager 140 may perform one or more other operations described herein.

In some aspects, the network node 110 may include a communication manager 150. As described in more detail elsewhere herein, the communication manager 150 may transmit, to a UE 120 via a source cell, a MAC-CE triggering a handover from the source cell to a target cell in an activated cell set configured for L1/L2 mobility; and receive, from the UE 120 via the target cell, a PRACH preamble to initiate an aperiodic CFRA procedure in the target cell in a RACH occasion in a PRACH slot that is associated with a slot offset indication. Additionally, or alternatively, the communication manager 150 may perform one or more other operations described herein.

As indicated above, FIG. 1 is provided as an example. Other examples may differ from what is described with regard to FIG. 1.

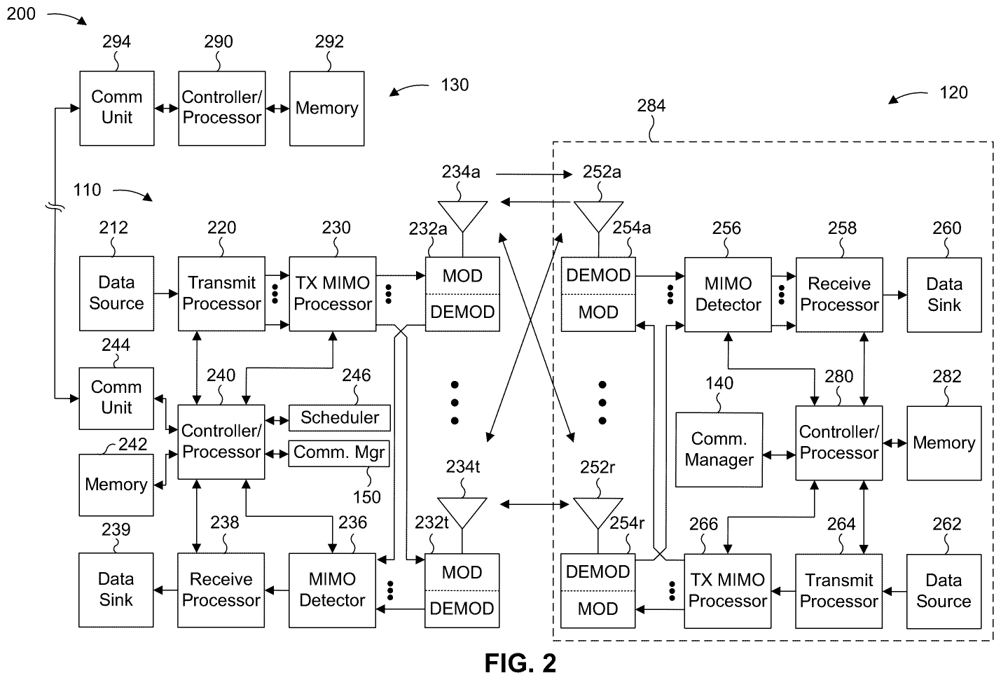

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

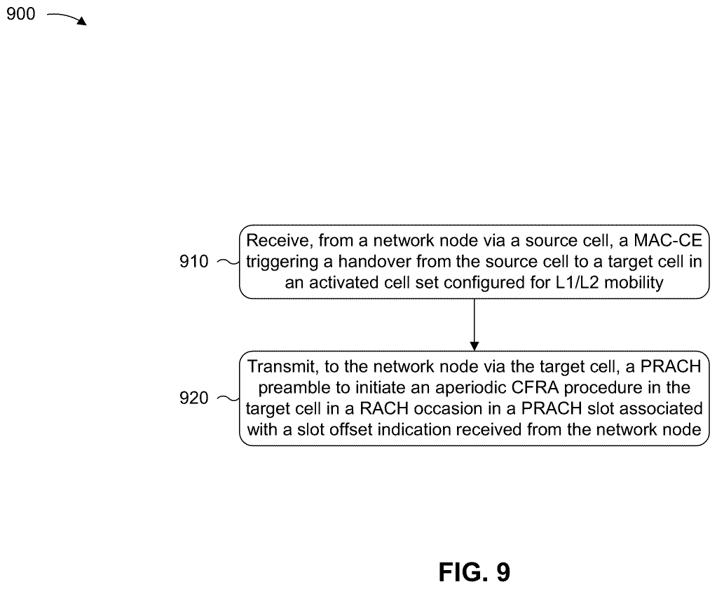

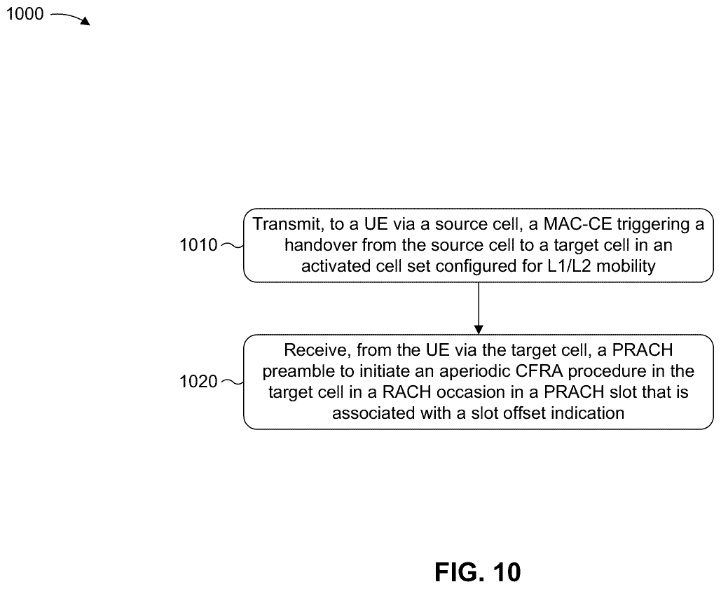

The controller/processor 240 of the network node 110, the controller/processor 280 of the UE 120, or any other component(s) of FIG. 2 may perform one or more techniques associated with an aperiodic RACH procedure for L1/L2 triggered mobility (LTM), as described in more detail elsewhere herein. For example, the controller/processor 240 of the network node 110, the controller/processor 280 of the UE 120, or any other component(s) of FIG. 2 may perform or direct operations of, for example, process 900 of FIG. 9, process 1000 of FIG. 10, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, or other processes as described herein. In some examples, executing instructions may include running the instructions, converting the instructions, compiling the instructions, or interpreting the instructions, among other examples.

In some aspects, one or more memories (e.g., memory 242 and/or memory 282) may include multiple memories, and one or more of the multiple memories may be configured to store processor-executable code that, when executed, may configure one or more processors (e.g., controller/processor 240 and/or controller/processor 280) to perform various functions described herein (as part of a processing system). In some other aspects, the processing system may be pre-configured to perform various functions described herein.

In some aspects, the UE 120 includes means for receiving, from a network node 110 via a source cell, a MAC-CE triggering a handover from the source cell to a target cell in an activated cell set configured for L1/L2 mobility; and/or means for transmitting, to the network node 110 via the target cell, a PRACH preamble to initiate an aperiodic CFRA procedure in the target cell in a RACH occasion in a PRACH slot associated with a slot offset indication received from the network node. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE 120 via a source cell, a MAC-CE triggering a handover from the source cell to a target cell in an activated cell set configured for L1/L2 mobility; and/or means for receiving, from the UE 120 via the target cell, a PRACH preamble to initiate an aperiodic CFRA procedure in the target cell in a RACH occasion in a PRACH slot that is associated with a slot offset indication. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

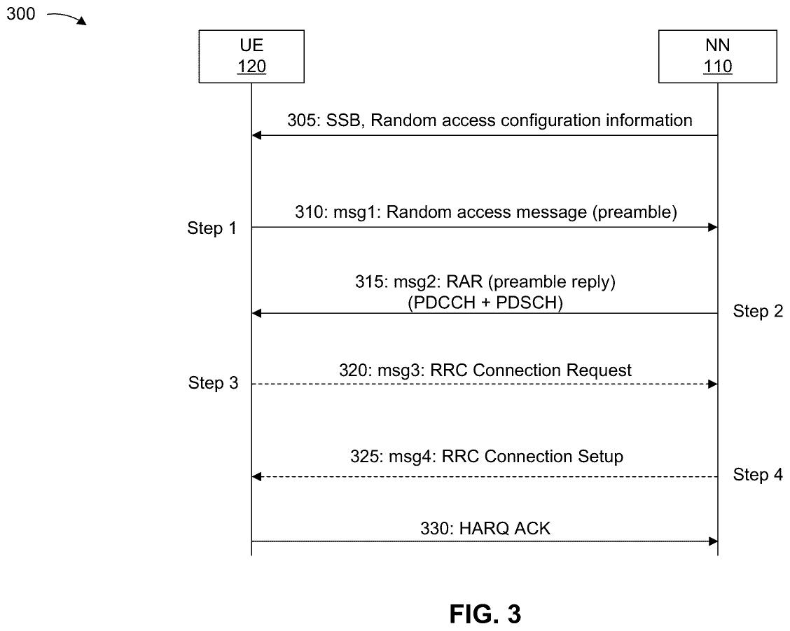

FIG. 3 is a diagram illustrating an example 300 of a four-step random access channel (RACH) procedure, in accordance with the present disclosure. As shown in FIG. 3, a network node 110 and a UE 120 may communicate with one another to perform the four-step RACH procedure.

As shown by reference number 305, the network node 110 may transmit, and the UE 120 may receive, one or more synchronization signal blocks (SSBs) and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical downlink control channel (PDCCH) order message that triggers a RACH procedure, such as for contention-free random access. The random access configuration information may include one or more parameters to be used in the four-step RACH procedure, such as one or more parameters for transmitting a random access message (RAM) and/or one or more parameters for receiving a random access response (RAR).

As shown by reference number 310, the UE 120 may transmit, and the network node 110 may receive, a random access message (RAM), which may include a preamble (sometimes referred to as a PRACH, a random access preamble, a PRACH preamble, or a RAM preamble). The message that includes the preamble may be referred to as a message 1, msg1, MSG1, a first message, or an initial message in a four-step RACH procedure. The RAM may include a random access preamble identifier.

As shown by reference number 315, the network node 110 may transmit, and the UE 120 may receive, an RAR as a reply to the preamble. The message that includes the RAR may be referred to as message 2, msg2, MSG2, or a second message in the four-step RACH procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step RACH procedure, the network node 110 may transmit, and the UE 120 may receive, a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step RACH procedure, the network node 110 may transmit the PDSCH communication for the RAR, as scheduled by the PDCCH communication. The RAR may be included in a MAC protocol data unit (PDU) of the PDSCH communication.

As shown by reference number 320, the UE 120 may transmit, and the network node 110 may receive, an RRC connection request message. The RRC connection request message may be referred to as message 3, msg3, MSG3, or a third message of the four-step RACH procedure. In some aspects, the RRC connection request may include a UE identifier, uplink control information (UCI), and/or a physical uplink shared channel (PUSCH) communication (e.g., an RRC connection request).

As shown by reference number 325, the network node 110 may transmit, and the UE 120 may receive, an RRC connection setup message. The RRC connection setup message may be referred to as message 4, msg4, MSG4, or a fourth message of the four-step RACH procedure. In some aspects, the RRC connection setup message may include the detected UE identifier, a timing advance value, and/or contention resolution information. As shown by reference number 330, if the UE 120 successfully receives the RRC connection setup message, the UE 120 may transmit a hybrid automatic repeat request (HARQ) acknowledgement (ACK) to the network node 110.

As indicated above, FIG. 3 is provided as an example. Other examples may differ from what is described with regard to FIG. 3.

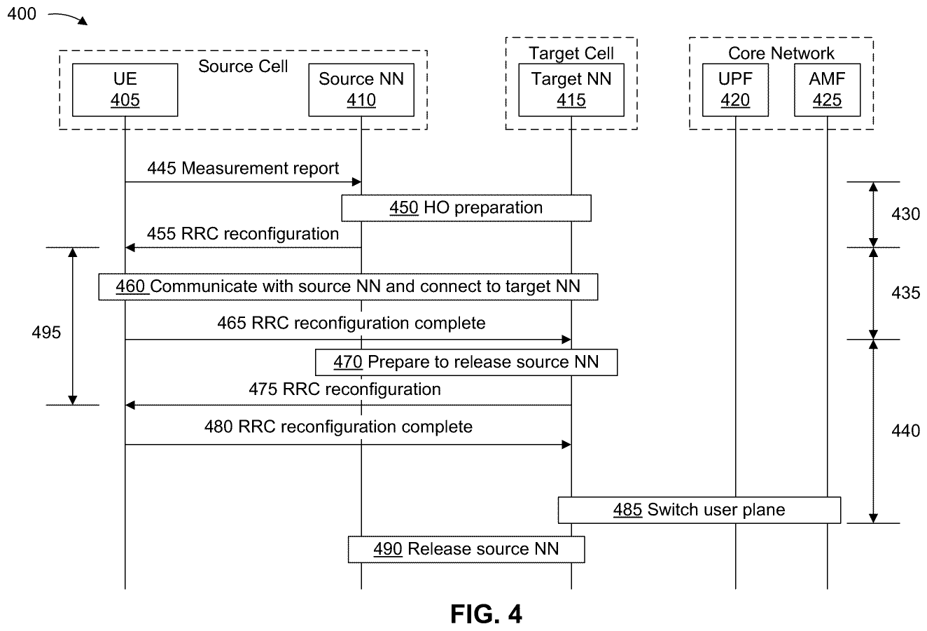

FIG. 4 is a diagram illustrating an example 400 of a make-before-break (MBB) handover procedure, in accordance with the present disclosure.

As shown in FIG. 4, the MBB handover procedure may involve a UE 405, a source network node 410, a target network node 415, a user plane function (UPF) device 420, and an access and mobility management function (AMF) device 425. In some examples, actions described as being performed by a network node (e.g., the source network node 410 or the target network node 415) may be performed by multiple network nodes. For example, configuration actions and/or core network communication actions may be performed by a first network node (e.g., a CU that controls a DU or a DU that controls an RU), and radio communication actions may be performed by a second network node (e.g., a DU controlled by a CU or an RU controlled by a DU). The UE 405 may correspond to the UE 120 described elsewhere herein. The source network node 410 and/or the target network node 415 may correspond to the network node 110 described elsewhere herein. The UPF device 420 and/or the AMF device 425 may correspond to the network controller 130 described elsewhere herein. The UE 405 and the source network node 410 may be connected (e.g., may have an RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions.

As shown in FIG. 4, the MBB handover procedure may include a handover preparation phase 430, a handover execution phase 435, and a handover completion phase 440. During the handover preparation phase 430, the UE 405 may report measurements that cause the source network node 410 and/or the target network node 415 to prepare for handover and trigger execution of the handover. During the handover execution phase 435, the UE 405 may execute the handover by performing a RACH procedure with the target network node 415 (e.g., a four-step RACH procedure, as described above with reference to FIG. 3, and/or a two-step RACH procedure) and establishing an RRC connection with the target network node 415. During the handover completion phase 440, the source network node 410 may forward one or more stored communications associated with the UE 405 to the target network node 415, and the UE 405 may be released from a connection with the source network node 410.

As shown by reference number 445, during the handover preparation phase 430, the UE 405 may perform one or more measurements, and may transmit a measurement report to the source network node 410 based at least in part on the one or more measurements (e.g., serving cell measurements and/or neighbor cell measurements). The measurement report may indicate, for example, an RSRP parameter, an RSRQ parameter, an RSSI parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, the source network node 410 may trigger a handover of the UE 405 to the target network node 415.

As shown by reference number 450, during the handover preparation phase 430, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an ACK to the source network node 410 in response to the handover request.

As shown by reference number 455, during the handover preparation phase 430, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a RACH preamble assignment for accessing the target network node 415. Reception of the RRC reconfiguration message, including the handover command, by the UE 405 may trigger the start of the handover execution phase 435.

As shown by reference number 460, during the handover execution phase 435, the UE 405 may execute the handover by performing a RACH procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., a sounding reference signal (SRS)) to the source network node 410, and/or may receive downlink data, downlink control information (DCI), and/or a downlink reference signal from the source network node 410.

As shown by reference number 465, upon successfully establishing a connection with the target network node 415 (e.g., via a RACH procedure) during the handover execution phase 435, the UE 405 may transmit an RRC reconfiguration completion message to the target network node 415. Reception of the RRC reconfiguration message by the target network node 415 may trigger the start of the handover completion phase 440.

As shown by reference number 470, during the handover completion phase 440, the source network node 410 and the target network node 415 may communicate with one another to prepare for release of the connection between the source network node 410 and the UE 405. In some aspects, the target network node 415 may determine that a connection between the source network node 410 and the UE 405 is to be released (e.g., after receiving the RRC reconfiguration message from the UE 405). In this case, the target network node 415 may transmit a handover connection setup completion message to the source network node 410. The handover connection setup completion message may cause the source network node 410 to stop transmitting data to the UE 405 and/or may cause the source network node 410 to stop receiving data from the UE 405. Additionally, or alternatively, the handover connection setup completion message may cause the source network node 410 to forward one or more communications associated with the UE 405 to the target network node 415 and/or to notify the target network node 415 of a status of one or more communications associated with the UE 405. For example, the source network node 410 may forward, to the target network node 415, one or more buffered downlink communications (e.g., downlink data) to be transmitted to the UE 405 and/or one or more uplink communications (e.g., uplink data) received from the UE 405. Additionally, or alternatively, the source network node 410 may notify the target network node 415 regarding a PDCP status associated with the UE 405 and/or a sequence number to be used for a downlink communication with the UE 405.

As shown by reference number 475, during the handover completion phase 440, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, during the handover completion phase 440, the UE may transmit an RRC reconfiguration completion message to the target network node 415 to indicate that the connection between the source network node 410 and the UE 405 is being released or has been released.

As shown by reference number 485, during the handover completion phase 440, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the MBB handover procedure, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

As indicated above, FIG. 4 is provided as an example. Other examples may differ from what is described with regard to FIG. 4.

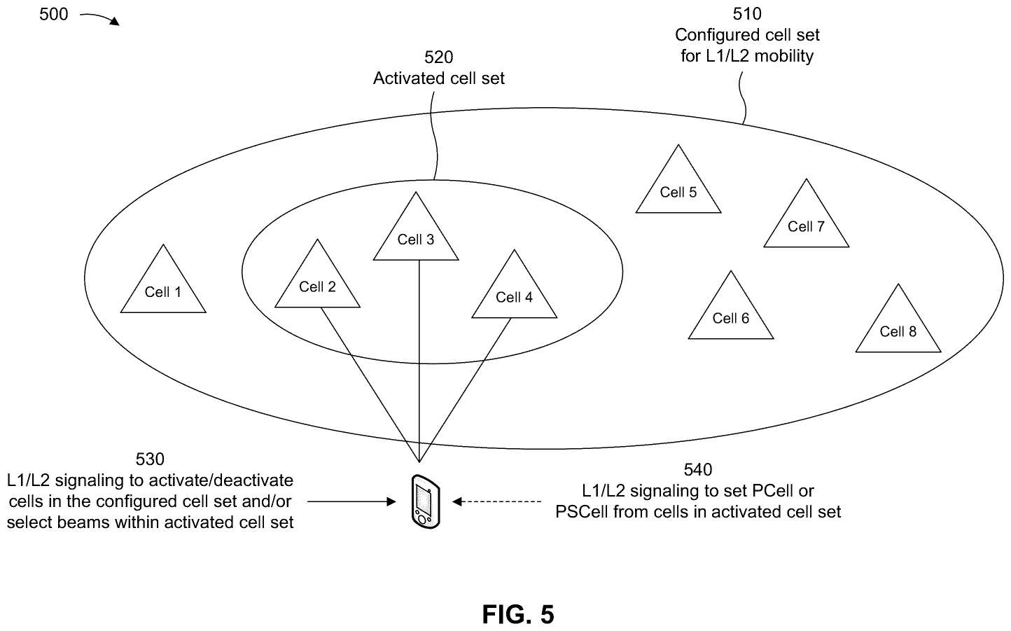

FIG. 5 is a diagram illustrating an example 500 of L1/L2 inter-cell mobility, in accordance with the present disclosure.

In a wireless network, a UE and a network node may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation at relatively high carrier frequencies (e.g., within FR2 or FR4), which may be associated with harsher propagation conditions than comparatively lower carrier frequencies. For example, relative to a sub-6 gigahertz (GHz) band (e.g., FR1), signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation at higher carrier frequencies is to facilitate efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., DCI for L1 signaling or a MAC-CE for L2 signaling) rather than semi-static Layer 3 (L3) RRC signaling to reduce latency, reduce overhead, and/or otherwise increase efficiency of the cell switch. For example, FIG. 5 illustrates an example 500 of an L1/L2 inter-cell mobility technique, which may be referred to as serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set and/or a deactivated cell set and/or to indicate a change to a special cell (SpCell) within the activated cell set, where an SpCell may be a primary cell (PCell) or a primary secondary cell (PSCell).

For example, as shown in FIG. 5, L1/L2 inter-cell mobility may use mechanisms that are generally similar to carrier aggregation, except that different cells that are configured for L1/L2 inter-cell mobility may be on the same carrier frequency. As shown in FIG. 5, a network node may configure a cell set 510 for L1/L2 inter-cell mobility (e.g., using RRC signaling). As further shown, an activated cell set 520 may include one or more cells in the configured cell set 510 that are activated and ready to use for data and/or control transfer. Accordingly, in the L1/L2 inter-cell mobility technique shown in FIG. 5, a deactivated cell set may include one or more cells that are included in the cell set 510 configured for L1/L2 inter-cell mobility but are not included in the activated cell set 520. However, the cells that are in the deactivated cell set can be readily activated, and thereby added to the activated cell set 520, using L1/L2 signaling. Accordingly, as shown by reference number 530, L1/L2 signaling can be used for mobility management of the activated cell set 520. For example, in some aspects, L1/L2 signaling can be used to activate cells within the configured cell set 510 (e.g., to add cells to the activated cell set 520), to deactivate cells in the activated cell set 520, and/or to select beams within the cells included in the activated cell set 520. In this way, the L1/L2 inter-cell mobility technique shown in FIG. 5 may enable seamless mobility among the cells included in the activated cell set 520 using L1/L2 signaling (e.g., using beam management techniques).

Furthermore, as shown by reference number 540, the L1/L2 inter-cell mobility technique may use L1/L2 signaling to set or change an SpCell (e.g., a PCell or PSCell) from the cells included in the activated cell set 520. Additionally, or alternatively, when the cell to become the new SpCell is in the deactivated cell set (e.g., is included in the cell set 510 configured for L1/L2 mobility but not the activated cell set 520), L1/L2 signaling can be used to move the cell from the deactivated cell set to the activated cell set 520 before further L1/L2 signaling is used to set the cell as the new SpCell. However, in the L1/L2 inter-cell mobility technique shown in FIG. 5, an L3 handover (e.g., using RRC signaling) is used to change the SpCell when the new SpCell is not included in the cell set 510 configured for L1/L2 inter-cell mobility. In such cases, RRC signaling associated with the L3 handover may be used to update the cells included in the cell set 510 configured for L1/L2 inter-cell mobility. Accordingly, L1/L2 inter-cell mobility can provide more efficient cell switching to support multi-beam operation, enabling lower latency and reduced overhead by using L1 signaling (e.g., DCI) and/or L2 signaling (e.g., a MAC-CE) rather than L3 signaling (e.g., RRC) to change the beam(s) that a UE uses to communicate over an access link.

As indicated above, FIG. 5 is provided as an example. Other examples may differ from what is described with regard to FIG. 5.

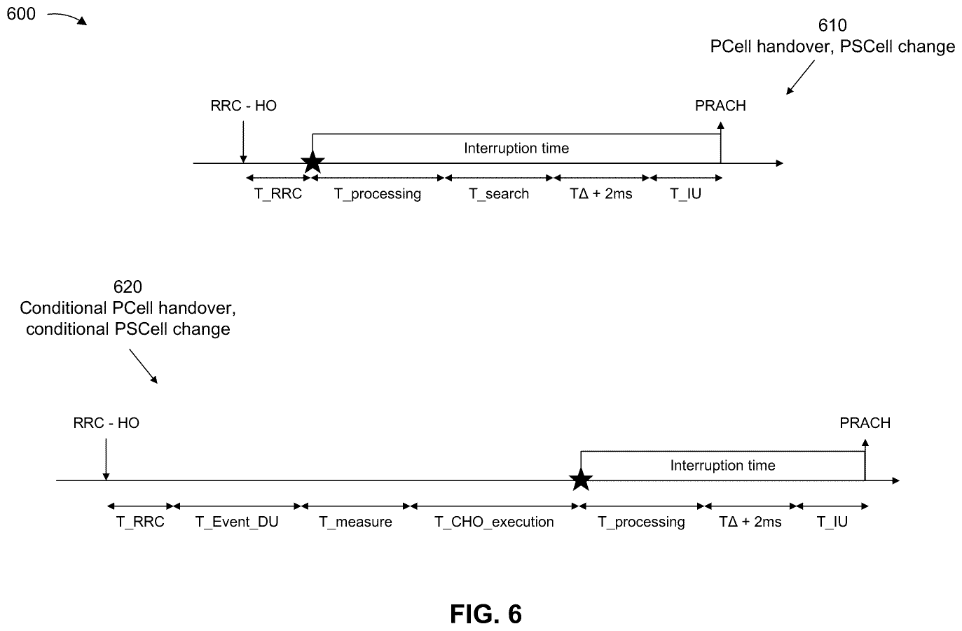

FIG. 6 is a diagram illustrating examples 600 of handover interruption, in accordance with the present disclosure. For example, as described herein, examples 600 generally relate to L3 handover scenarios, where RRC signaling is used to trigger a handover from a source cell to a target cell.

For example, as described herein, a wireless network may support L1/L2 triggered mobility (LTM) to enable fast connected mode mobility that may reduce data interruption relative to L3 triggered mobility by reducing RRC signaling and associated processing delays and/or by reducing downlink synchronization and/or RACH procedure times. For example, in L3 triggered mobility, an RRC configuration for a target cell needs to be delivered to the UE, and the UE needs to be reconfigured to communicate with the target cell based on the RRC signaling. Accordingly, one potential approach to reducing data interruption due to L3 mobility may be to provide the RRC configuration in advance, and then reduce a downlink synchronization and/or RACH procedure time. For example, in an existing L3 handover procedure (e.g., described above with reference to FIG. 4), where a UE is indicated to switch to a new (target) cell, the UE may need to first establish downlink synchronization and then establish uplink synchronization on the target cell via a contention-free random access (CFRA) procedure on the target cell before access link communications can be enabled on the target cell. Although the UE can generally start the RACH procedure on the target cell as soon as the UE establishes downlink synchronization on the target cell, a delay in initiating the RACH procedure can be large, due to uncertainty regarding a next available RACH occasion in which the UE can transmit a PRACH toward the target cell.

For example, referring to FIG. 6, reference number 610 illustrates an example timeline that includes various delays for a PCell handover and/or a PSCell change. As shown, the PCell handover and/or PSCell change may be triggered by L3 signaling that carries a handover command (e.g., shown as “RRC-HO”), which is followed by various delays that result in a handover interruption time. For example, as shown in FIG. 6, the L3 handover command is followed by an RRC procedure delay (e.g., T_RRC), which is followed by an interruption time that includes a UE processing time (e.g., T_processing, which can be up to 20 milliseconds (ms) when the source and target cells are in the same frequency range, or up to 40 ms when the source and target cells are in different frequency ranges) and a search time that the UE requires to search a target cell (e.g., T_search, which can be 0 ms when the target cell is known when the handover command is received by the UE, T_rs when the target cell is an unknown intra-frequency cell in FR1, 8×T_rs when the target cell is an unknown intra-frequency cell in FR2, 3×T_rs when the target cell is an unknown inter-frequency cell in FR1, or 8×3×T_rs when the target cell is an unknown inter-frequency cell in FR2, where T_rs is an SSB measurement timing configuration (SMTC) periodicity of the target cell). As further shown, the interruption time may include a synchronization time (e.g., TΔ+2 ms, where TΔ=T_rs) associated with fine time tracking and acquiring full timing information for the target cell, and an interruption uncertainty (e.g., T_IU) that corresponds to the interruption uncertainty in acquiring a first available PRACH occasion (or RACH occasion) in the target cell.

Furthermore, as shown by reference number 620, a conditional PCell handover and/or a conditional PSCell change may also be subject to various delays that contribute to a handover interruption time. For example, in addition to the RRC procedure delay (e.g., T_RRC), the UE processing time (e.g., T_processing, the synchronization time (e.g., TΔ+2 ms), and the interruption uncertainty (e.g., T_IU), a conditional PCell handover or a conditional PSCell change may be subject to a delay uncertainty (e.g., T_Event_DU) that represents the time from when the UE successfully decodes a conditional handover command until a condition exists at a measurement reference point that will trigger the conditional handover, a measurement time delay (e.g., T_measure) defined from the end of T_Event_DU until the UE executes a handover to a target cell and the interruption time starts, and a conditional handover execution time (T_CHO_execution) that represents a UE conditional execution preparation time.

Accordingly, when a UE receives an RRC message triggering a PCell handover, a PSCell change, a conditional PCell handover, or a conditional PSCell change, the UE may experience an interruption time that starts at a time when the UE starts to execute the handover to the target cell (e.g., shown in FIG. 6 using a star icon) and ends at a time when the UE starts to transmit a PRACH toward the target cell to initiate a RACH procedure in the target cell. Because the UE can transmit and receive data in the target cell only after the RACH procedure is complete, techniques based on LTM may be used to reduce the handover interruption time. For example, in some cases, the RRC procedure delay (e.g., T_RRC) and the UE processing time (e.g., T_processing) may be reduced by using RRC signaling to preconfigure one or more target cells for LTM. Additionally, or alternatively, the time for fine time tracking and acquiring full timing information of the target cell (e.g., TΔ) may be reduced by requesting that a UE maintain downlink synchronization for one or more target cells configured for LTM prior to an LTM trigger (e.g., such that the UE only needs to establish uplink synchronization to enable communication in a target cell after an LTM trigger). Furthermore, in some cases, a RACH-related delay may be reduced or eliminated via a PDCCH-ordered RACH procedure toward a target cell configured for LTM prior to an LTM trigger. However, a PDCCH-ordered RACH procedure may not be feasible for an inter-frequency LTM target cell depending on a UE implementation. Furthermore, these techniques are unable to reduce the interruption uncertainty in acquiring the first available PRACH occasion in the target cell (e.g., T_IU), which can be up to a summation of an SSB-to-PRACH occasion association period and 10 ms.

For example, existing techniques to perform a contention-free RACH (CFRA) procedure to execute a handover are subject to a large delay, which is primarily caused by a large RACH resource periodicity. For example, the RACH resource periodicity in a target cell may be 10 ms, 20 ms, 40 ms, 80 ms, or 160 ms (e.g., a frame duration may be 10 ms, and a RACH resource may have a periodicity such that the RACH resource is available once in every 1, 2, 4, 8, or 16 frames). Accordingly, after the UE receives a handover command or a conditional handover command and performs all of the procedures leading up to the interruption uncertainty time, the UE may be ready to communicate with the target cell on a downlink, but still needs to perform a RACH procedure in the target cell to enable uplink synchronization. However, at the moment that the uncertainty time begins, the next periodic RACH resource that is available may be 10 ms, 20 ms, 40 ms, 80 ms, or 160 ms away (e.g., depending on the RACH resource periodicity). Accordingly, some aspects described herein relate to techniques to configure an aperiodic RACH resource that a UE can use to transmit a PRACH preamble to initiate a CFRA procedure in a target cell. In this way, relative to relying on a periodic RACH resource to initiate the CFRA procedure in a target cell, using the aperiodic RACH resource may significantly reduce the interruption uncertainty in acquiring the first available PRACH occasion in the target cell, which may reduce the latency or delay associated with when the UE can start to transmit and receive data in the target cell.

As indicated above, FIG. 6 is provided as an example. Other examples may differ from what is described with regard to FIG. 6.

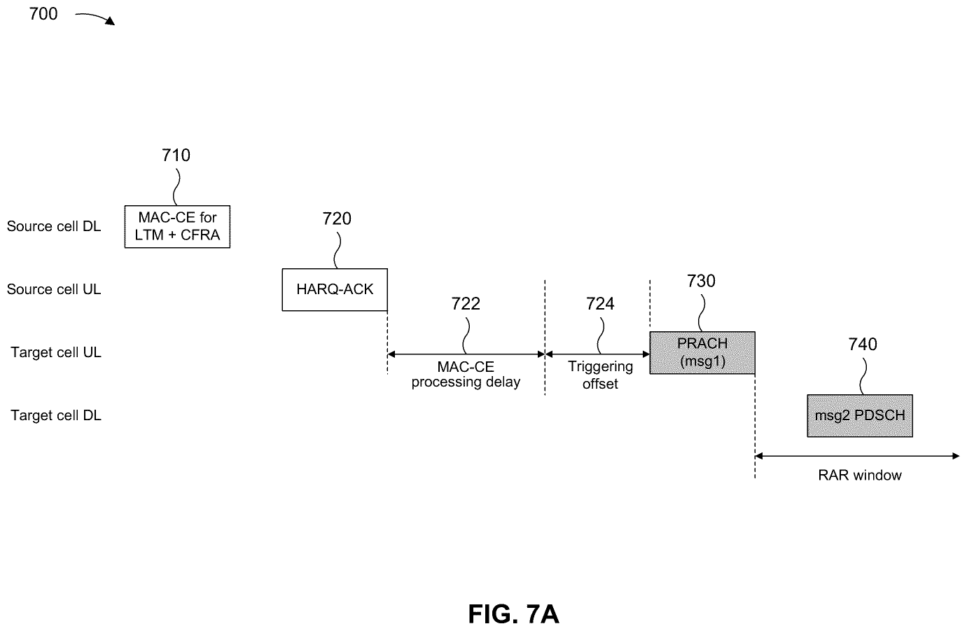

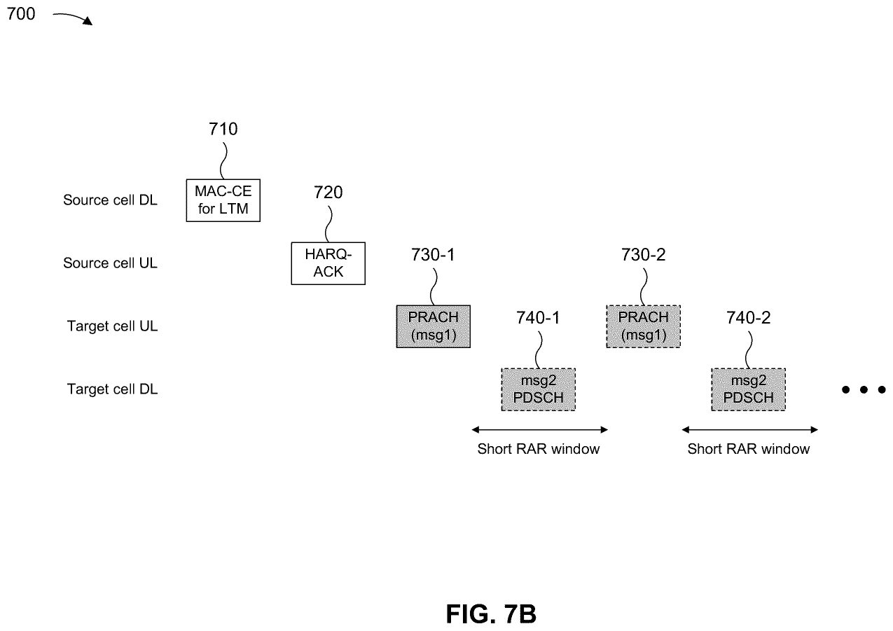

FIGS. 7A-7B are diagrams illustrating examples 700 associated with an aperiodic RACH procedure for L1/L2 triggered mobility, in accordance with the present disclosure. As shown in FIGS. 7A-7B, examples 700 include communication between a network node and a UE. For example, in some aspects, the network node may be a CU, a DU, or another suitable node that controls a source cell and a target cell that are configured for L1/L2 triggered mobility. In some aspects, the network node and the UE may be included in a wireless network, such as wireless network 100. In some aspects, the network node and the UE may communicate via a wireless access link, which may include an uplink and a downlink. For example, as shown, the network node may transmit one or more messages to the UE on the downlink via the source cell and/or via the target cell, and the UE may transmit one or more messages to the network on the uplink via the source cell and/or via the target cell.

In some aspects, as described herein, the network node may transmit, to the UE via the source cell, an RRC configuration that indicates various PRACH parameters associated with a PRACH resource that the UE may use to transmit a PRACH preamble to initiate a CFRA procedure in the target cell (e.g., following a MAC-CE that triggers L1/L2 mobility to the target cell). For example, while the UE is communicating with the network node via the source cell, the network node may transmit, and the UE may receive, an RRC configuration that indicates one or more time-frequency resource parameters, one or more PRACH waveform parameters, and/or one or more power control parameters that the UE may apply when transmitting a PRACH in the target cell.

For example, in some aspects, the one or more time-frequency resource parameters may include a msg1-FrequencyStart parameter that indicates an offset of a lowest PRACH transmission occasion in a frequency domain relative to a physical resource block (PRB) with index 0 (PRB0), a slot periodicity parameter that indicates a periodicity of a PRACH slot that includes a RACH occasion in which the UE can transmit a PRACH preamble to initiate an aperiodic CFRA procedure, and/or a number of PRACH opportunities that indicates a number of times that the UE can transmit a PRACH to attempt the aperiodic CFRA procedure. Furthermore, in some aspects, the one or more PRACH waveform parameters indicated in the RRC configuration provided by the source cell may include a preamble format parameter (e.g., indicating preamble format 0, 1, 2, 3, A1/A2/A3, B1/B2/B3/B4, or C0/C2 configured by a parameter, such as a prach-ConfigurationIndex parameter, that indicates a frame number and subframe number within the frame that has PRACH resources), a subcarrier spacing (SCS) parameter (e.g., indicating an SCS for preamble format A, B, and/or C), a prach-RootSequenceIndex parameter (e.g., indicating a root sequence index of a PRACH waveform), and/or a zeroCorrelationZoneConfig parameter (e.g., indicating a unit of a cyclic shift in a time domain). Furthermore, in some aspects, the one or more power control waveform parameters indicated in the RRC configuration provided by the source cell may include a preambleReceivedTargetPower parameter (e.g., indicating a target power level for a PRACH transmission at the network receiver side) and/or a powerRampingStep parameter (e.g., indicating a step size for increasing or ramping up a PRACH transmission power over successive PRACH transmissions).

Accordingly, as described herein, the RRC configuration provided by the source cell may generally configure various PRACH parameters that a UE may use to transmit a PRACH preamble to initiate an aperiodic CFRA procedure in a target cell, and one or more remaining PRACH parameters may be dynamically indicated. For example, as shown in FIG. 7A, and by reference number 710, the network node may transmit, to the UE via the source cell, a MAC-CE that triggers a handover from the source cell to a target cell configured for L1/L2 mobility, and the MAC-CE may also include a CFRA trigger that dynamically indicates one or more PRACH parameters that the UE may use to transmit the PRACH preamble to initiate the aperiodic CFRA procedure in the target cell. For example, in some aspects, the MAC-CE that triggers the handover to the target cell may include a slot offset indication, which may indicate a PRACH slot in which the UE is to transmit the PRACH preamble to initiate the aperiodic CFRA procedure in the target cell. In addition, the MAC-CE may indicate a RACH occasion index within the PRACH slot, a preamble index for the PRACH that the UE is to transmit to initiate the aperiodic CFRA procedure, and/or a transmission configuration indication (TCI) state associated with an index of an SSB to be used as a pathloss reference signal for determining a transmission power of the PRACH. Accordingly, in some aspects, the UE may use the slot offset indication provided in the MAC-CE to determine a PRACH slot in which to transmit the PRACH preamble to initiate the aperiodic CFRA procedure, may use the RACH occasion index indicated in the MAC-CE to determine a RACH occasion within the PRACH slot, and may use the preamble index indicated in the MAC-CE to determine the preamble associated with the PRACH that is transmitted to initiate the aperiodic CFRA procedure in the target cell.

For example, as further shown in FIG. 7A, and by reference number 720, the UE may transmit a HARQ ACK to the network node via the source cell uplink to acknowledge the MAC-CE triggering mobility to the target cell and the CFRA trigger carried in the MAC-CE. As further shown by reference number 722, the transmission of the HARQ ACK may be followed by a MAC-CE processing delay, which is a common processing delay (e.g., 3 ms) that is applicable to all UEs. As further shown by reference number 724, the slot offset indication may be associated with a triggering offset that may be defined relative to an end of the MAC-CE processing delay, where the triggering offset may correspond to a number of slots after the end of the MAC-CE processing delay. In some aspects, the slot offset indication (and associated triggering offset) may be based on UE capability information that the UE transmits to the network node, which may indicate a minimum value for the slot offset indication (e.g., from zero to a few slots, depending on the UE capability). Accordingly, as shown by reference number 730, the UE may transmit a PRACH (e.g., corresponding to msg1) to the target cell in a RACH occasion that is based on the slot offset indication and the RACH occasion index indicated in the MAC-CE (e.g., using the preamble index indicated in the MAC-CE). Furthermore, in some aspects, the UE may use the PRACH parameters indicated in the MAC-CE in conjunction with the RRC-configured PRACH parameters to transmit the PRACH preamble to initiate the aperiodic CFRA procedure in the target cell. As further shown in FIG. 7A, and by reference number 740, the UE may receive an RAR message from the target cell (e.g., a msg2 PDSCH) during an RAR window, at which time the aperiodic CFRA procedure may be considered complete and the UE can then start to transmit uplink data and/or receive downlink data via the target cell.

Additionally, or alternatively, as described herein and shown in FIG. 7B, the network node may configure multiple PRACH opportunities for the UE to initiate the aperiodic CFRA procedure with a relatively short RAR window (e.g., the RAR window may have a duration that is based on the number of PRACH opportunities configured for the UE, where the duration of the RAR window may be shorter when multiple PRACH opportunities are configured, such that the UE can retransmit a PRACH sooner to reduce the latency associated with the handover to the target cell when an RAR message (e.g., a msg2 PDSCH) is not received within an RAR window. For example, as shown in FIG. 7B and by reference number 730-1, the UE may transmit an initial PRACH preamble to initiate the aperiodic CFRA procedure in the target cell, and may then monitor a downlink from the target cell for an RAR message (e.g., a msg2 PDSCH) during a short RAR window, as shown by reference number 740-1. In some aspects, as shown by reference number 730-2, the UE may retransmit the PRACH (e.g., msg1) to initiate the aperiodic CFRA procedure in the target cell in cases where the RAR message is not received during the RAR window, and the UE may again monitor a downlink from the target cell for an RAR message during a short RAR window, as shown by reference number 740-2. In this way, the UE may attempt to initiate the aperiodic CFRA procedure in the target cell multiple times until the RAR message is received from the target cell or the number of PRACH opportunities configured for the UE have been exhausted.

In some aspects, when the UE transmits or retransmits the PRACH preamble to initiate the aperiodic CFRA procedure, the UE may determine a transmission power to apply to the PRACH transmission. For example, in some aspects, the MAC-CE that is transmitted via the source cell to trigger the handover to the target cell may indicate a TCI state associated with the target cell, and the UE may use a parameter that indicates an SSB transmission power (e.g., ss-PBCH-BlockPower) and an RSRP measurement associated with the TCI state indicated in the MAC-CE to estimate a pathloss associated with the target cell (e.g., based on a difference between the SSB transmission power indicated in the ss-PBCH-BlockPower parameter and the RSRP measurement associated with the TCI state indicated in the MAC-CE). In some aspects, the UE may then determine a transmission power for the PRACH transmission based on the estimated pathloss and a parameter (e.g., preambleReceivedTargetPower) that indicates a target power level at the network receiver side. Furthermore, in cases where multiple PRACH opportunities are configured and the UE retransmits the PRACH one or more times (e.g., responsive to not detecting the RAR message within the RAR window), the UE may apply a power ramping parameter (e.g., according to a powerRampingStep parameter) to increase the PRACH transmission power in successive PRACH slots until the RAR message is received from the target cell or the number of PRACH opportunities configured for the UE have been exhausted.

As indicated above, FIGS. 7A-7B are provided as examples. Other examples may differ from what is described with regard to FIGS. 7A-7B.

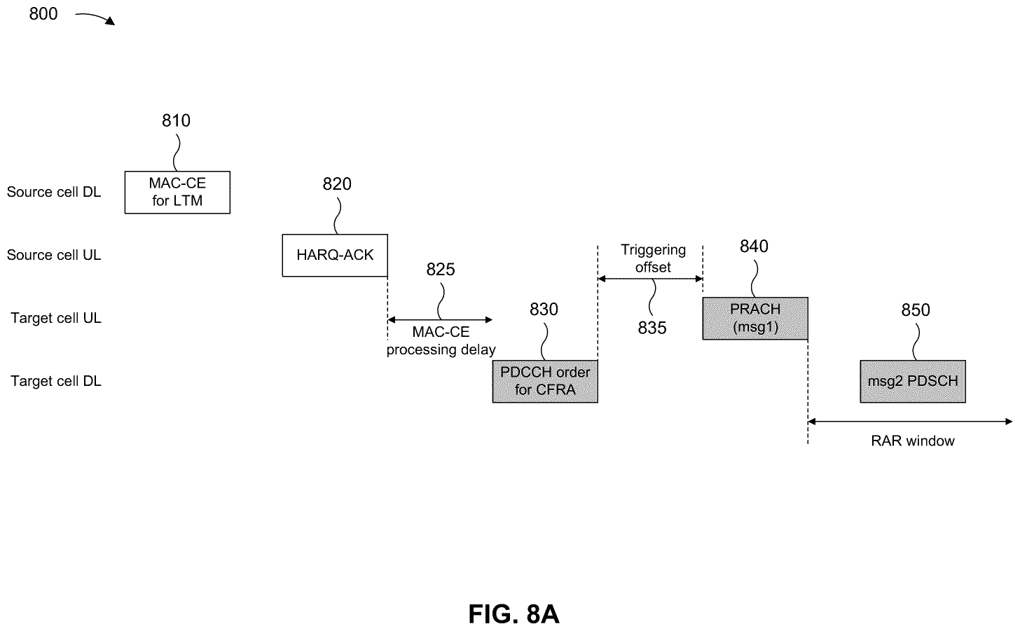

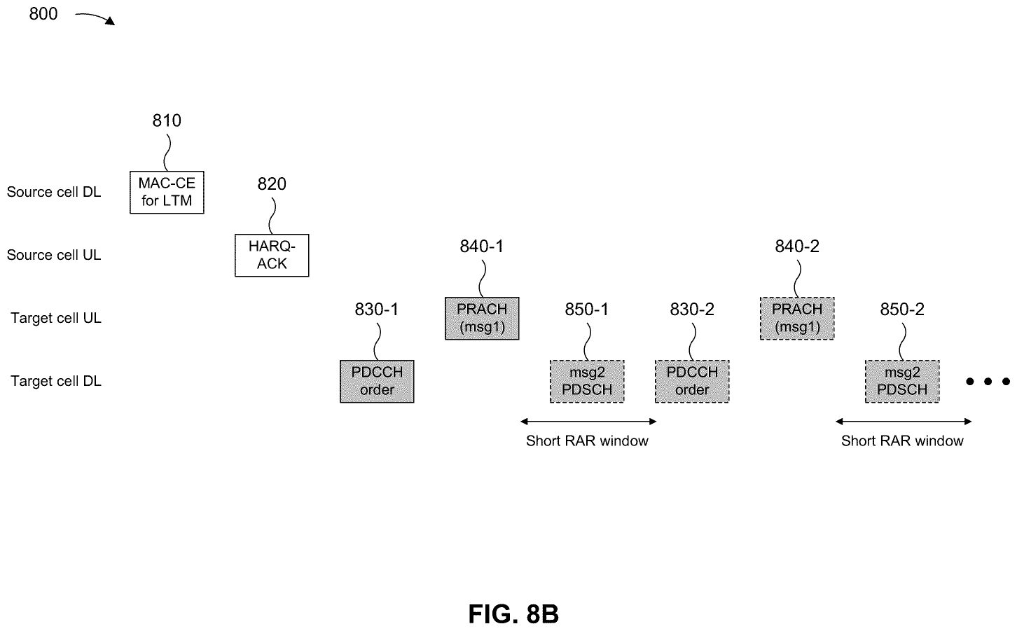

FIGS. 8A-8B are diagrams illustrating examples 800 associated with an aperiodic RACH procedure for L1/L2 triggered mobility, in accordance with the present disclosure. As shown in FIGS. 8A-8B, examples 800 include communication between a network node and a UE. For example, in some aspects, the network node may be a CU, a DU, or another suitable node that controls a source cell and a target cell that are configured for L1/L2 triggered mobility. In some aspects, the network node and the UE may be included in a wireless network, such as wireless network 100. In some aspects, the network node and the UE may communicate via a wireless access link, which may include an uplink and a downlink. For example, as shown, the network node may transmit one or more messages to the UE on the downlink via the source cell and/or via the target cell, and the UE may transmit one or more messages to the network on the uplink via the source cell and/or via the target cell.

In some aspects, as described herein, the network node may transmit, to the UE via the source cell, an RRC configuration that indicates various PRACH parameters associated with a PRACH resource that the UE may use to transmit a PRACH preamble to initiate a CFRA procedure in the target cell (e.g., following a MAC-CE that triggers L1/L2 mobility to the target cell). For example, while the UE is communicating with the network node via the source cell, the network node may transmit, and the UE may receive, an RRC configuration that indicates one or more time-frequency resource parameters, one or more PRACH waveform parameters, and/or one or more power control parameters that the UE may apply when transmitting a PRACH in the target cell.

For example, in some aspects, the one or more time-frequency resource parameters may include a msg1-FrequencyStart parameter that indicates an offset of a lowest PRACH transmission occasion in a frequency domain relative to a physical resource block (PRB) with index 0 (PRB0). Furthermore, in some aspects, the one or more PRACH waveform parameters indicated in the RRC configuration provided by the source cell may include a preamble format parameter (e.g., indicating preamble format 0, 1, 2, 3, A1/A2/A3, B1/B2/B3/B4, or C0/C2 configured by a prach-ConfigurationIndex parameter), a subcarrier spacing (SCS) parameter (e.g., indicating an SCS for preamble format A, B, and/or C), a prach-RootSequenceIndex parameter (e.g., indicating a root sequence index of a PRACH waveform), and/or a zeroCorrelationZoneConfig parameter (e.g., indicating a unit of a cyclic shift in a time domain). Furthermore, in some aspects, the one or more power control waveform parameters indicated in the RRC configuration provided by the source cell may include a preambleReceivedTargetPower parameter (e.g., indicating a target power level for a PRACH transmission at the network receiver side) and/or a powerRampingStep parameter (e.g., indicating a step size for increasing or ramping up a PRACH transmission power over successive PRACH transmissions).

Accordingly, as described herein, the RRC configuration provided by the source cell may generally configure various PRACH parameters that a UE may use to transmit a PRACH preamble to initiate an aperiodic CFRA procedure in a target cell, and one or more remaining PRACH parameters may be dynamically indicated. For example, as shown in FIG. 8A, and by reference number 810, the network node may transmit, to the UE via the source cell, a MAC-CE that triggers a handover from the source cell to a target cell configured for L1/L2 mobility. As further shown in FIG. 8A, and by reference number 820, the UE may then transmit a HARQ ACK to the network node via the source cell uplink to acknowledge the MAC-CE triggering mobility to the target cell. As further shown by reference number 825, the transmission of the HARQ ACK may be followed by a MAC-CE processing delay, which is a common processing delay (e.g., 3 ms) that is applicable to all UEs.

As further shown in FIG. 8A, and by reference number 830, the network node may then transmit, to the UE via the target cell, a PDCCH order that includes a CFRA trigger that dynamically indicates one or more PRACH parameters that the UE may use to transmit the PRACH preamble to initiate the aperiodic CFRA procedure in the target cell. For example, in some aspects, the PDCCH order that includes the CFRA trigger may include a slot offset indication in a DCI field of the PDCCH order, where the slot offset indication may indicate a PRACH slot in which the UE is to transmit the PRACH preamble to initiate the aperiodic CFRA procedure in the target cell. In addition, the DCI field of the PDCCH order may indicate a RACH occasion index within the PRACH slot, a preamble index for the PRACH that the UE is to transmit to initiate the aperiodic CFRA procedure, and/or a TCI state associated with an index of an SSB to be used as a pathloss reference signal for determining a transmission power of the PRACH. Accordingly, in some aspects, the UE may use the slot offset indication provided in the PDCCH order to determine a PRACH slot in which to transmit the PRACH preamble to initiate the aperiodic CFRA procedure, may use the RACH occasion index indicated in the PDCCH order to determine a RACH occasion within the PRACH slot, and may use the preamble index indicated in the PDCCH order to determine the preamble associated with the PRACH that is transmitted to initiate the aperiodic CFRA procedure in the target cell.

As further shown by reference number 835, the slot offset indication may be associated with a triggering offset that may be defined relative to the PDCCH order, where the triggering offset may correspond to a number of slots after the PDCCH order. In some aspects, the slot offset indication (and associated triggering offset) may be based on UE capability information that the UE transmits to the network node, which may indicate a minimum value for the slot offset indication (e.g., from zero to a few slots, depending on the UE capability). Accordingly, as shown by reference number 840, the UE may transmit a PRACH (e.g., corresponding to msg1) to the target cell in a RACH occasion that is based on the slot offset indication and the RACH occasion index indicated in the PDCCH order (e.g., using the preamble index indicated in the PDCCH order). Furthermore, in some aspects, the UE may use the PRACH parameters indicated in the PDCCH order in conjunction with the RRC-configured PRACH parameters to transmit the PRACH preamble to initiate the aperiodic CFRA procedure in the target cell. As further shown in FIG. 8A, and by reference number 850, the UE may receive an RAR message from the target cell (e.g., a msg2 PDSCH) during an RAR window, at which time the aperiodic CFRA procedure may be considered complete and the UE can then start to transmit uplink data and/or receive downlink data via the target cell.

Additionally, or alternatively, as described herein and shown in FIG. 8B, the network node may retransmit the PDCCH order to trigger the CFRA procedure in the target cell multiple times with a relatively short RAR window in cases where the network node does not detect the PRACH in the target cell. For example, as shown in FIG. 8B and by reference number 830-1, the network node may transmit the PDCCH order via the target cell, which may cause the UE to transmit an initial PRACH preamble to initiate the aperiodic CFRA procedure in the target cell, as shown by reference number 840-1. As shown by reference number 850-1, the UE may then monitor a downlink from the target cell for an RAR message (e.g., a msg2 PDSCH) during a short RAR window. In some aspects, as shown by reference number 830-2, the network node may retransmit the PDCCH order via the target cell in cases where the PRACH is not detected, which may cause the UE to retransmit the PRACH preamble to initiate the aperiodic CFRA procedure in the target cell, as shown by reference number 840-2. The UE may then again monitor the downlink from the target cell for the RAR message during a short RAR window, as shown by reference number 850-2. In this way, the target cell may transmit (or retransmit) the PDCCH order to the UE to trigger the aperiodic CFRA procedure in the target cell multiple times until the PRACH transmitted by the UE is detected.

In some aspects, when the UE transmits or retransmits the PRACH preamble to initiate the aperiodic CFRA procedure, the UE may determine a transmission power to apply to the PRACH transmission. For example, in some aspects, the MAC-CE that is transmitted via the source cell to trigger the handover to the target cell may indicate a TCI state associated with the target cell, and the UE may use a parameter that indicates an SSB transmission power (e.g., ss-PBCH-BlockPower) and an RSRP measurement associated with the TCI state indicated in the MAC-CE to estimate a pathloss associated with the target cell (e.g., based on a difference between the SSB transmission power indicated in the ss-PBCH-BlockPower parameter and the RSRP measurement associated with the TCI state indicated in the MAC-CE). In some aspects, the UE may then determine a transmission power for the PRACH transmission based on the estimated pathloss and a parameter (e.g., preambleReceivedTargetPower) that indicates a target power level at the network receiver side. Furthermore, in cases where the UE receives the PDCCH order to trigger the aperiodic CFRA multiple times such that the UE retransmits the PRACH one or more times (e.g., responsive to the network node not detecting the PRACH transmission from the UE), the UE may apply a power ramping parameter (e.g., according to a powerRampingStep parameter) to increase the PRACH transmission power in successive PRACH slots until the PRACH is detected by the network node.

As indicated above, FIGS. 8A-8B are provided as examples. Other examples may differ from what is described with regard to FIGS. 8A-8B.

FIG. 9 is a diagram illustrating an example process 900 performed, for example, by a UE, in accordance with the present disclosure. Example process 900 is an example where the UE (e.g., UE 120) performs operations associated with an aperiodic RACH procedure for LTM.

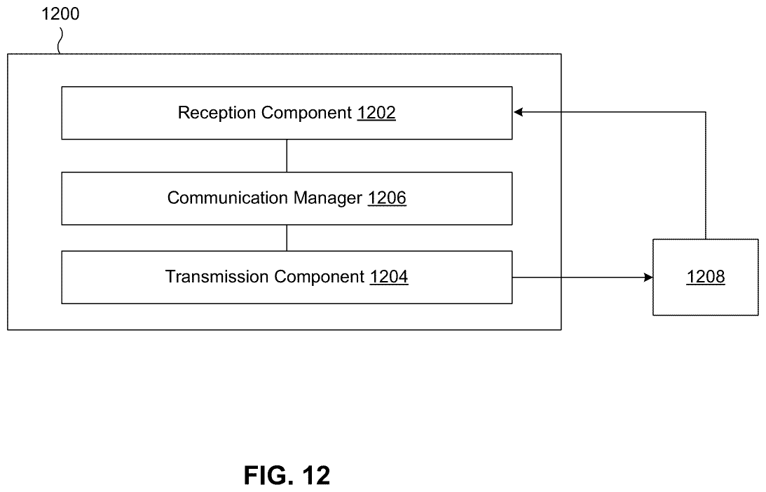

As shown in FIG. 9, in some aspects, process 900 may include receiving, from a network node via a source cell, a MAC-CE triggering a handover from the source cell to a target cell in an activated cell set configured for L1/L2 mobility (block 910). For example, the UE (e.g., using reception component 1202 and/or communication manager 1206, depicted in FIG. 12) may receive, from a network node via a source cell, a MAC-CE triggering a handover from the source cell to a target cell in an activated cell set configured for L1/L2 mobility, as described above.

As further shown in FIG. 9, in some aspects, process 900 may include transmitting, to the network node via the target cell, a PRACH preamble to initiate an aperiodic CFRA procedure in the target cell in a RACH occasion in a PRACH slot associated with a slot offset indication received from the network node (block 920). For example, the UE (e.g., using transmission component 1204 and/or communication manager 1206, depicted in FIG. 12) may transmit, to the network node via the target cell, a PRACH preamble to initiate an aperiodic CFRA procedure in the target cell in a RACH occasion in a PRACH slot associated with a slot offset indication received from the network node, as described above.

Process 900 may include additional aspects, such as any single aspect or any combination of aspects described below and/or in connection with one or more other processes described elsewhere herein.

In a first aspect, the slot offset indication is included in the MAC-CE triggering the handover from the source cell to the target cell.

In a second aspect, alone or in combination with the first aspect, the MAC-CE triggering the handover from the source cell to the target cell indicates a RACH occasion index associated with the RACH occasion and a preamble index associated with the PRACH.

In a third aspect, alone or in combination with one or more of the first and second aspects, process 900 includes transmitting, to the network node via the source cell, HARQ feedback to acknowledge the MAC-CE triggering the handover, the slot offset indication being defined relative to an uplink message carrying the HARQ feedback and a processing delay associated with the MAC-CE.

In a fourth aspect, alone or in combination with one or more of the first through third aspects, process 900 includes responsive to a determination that an RAR was not received from the target cell during an RAR window, retransmitting, to the network node via the target cell, the PRACH preamble to initiate the aperiodic CFRA procedure in the target cell in a RACH occasion in a subsequent PRACH slot responsive to the MAC-CE configuring multiple PRACH opportunities.

In a fifth aspect, alone or in combination with one or more of the first through fourth aspects, the RAR window has a short duration responsive to the MAC-CE configuring multiple PRACH opportunities.

In a sixth aspect, alone or in combination with one or more of the first through fifth aspects, process 900 includes receiving, from the network node via the source cell, an RRC configuration that indicates a periodicity for the multiple PRACH opportunities and a number of PRACH opportunities.

In a seventh aspect, alone or in combination with one or more of the first through sixth aspects, process 900 includes receiving, from the network node via the target cell, a PDCCH order that includes a trigger for initiating the aperiodic CFRA procedure in the target cell, the slot offset indication included in a DCI field in the PDCCH order.

In an eighth aspect, alone or in combination with one or more of the first through seventh aspects, process 900 includes transmitting, to the network node via the source cell, HARQ feedback to acknowledge the MAC-CE triggering the handover, wherein the PDCCH order is received after a processing delay associated with the MAC-CE that is defined relative to an uplink message carrying the HARQ feedback.

In a ninth aspect, alone or in combination with one or more of the first through eighth aspects, the slot offset indication is defined relative to a slot in which the PDCCH order is received.

In a tenth aspect, alone or in combination with one or more of the first through ninth aspects, process 900 includes receiving, from the network node via the target cell, a subsequent PDCCH order that includes a trigger for initiating the aperiodic CFRA procedure in the target cell, and retransmitting, to the network node via the target cell, the PRACH preamble to initiate the aperiodic CFRA procedure in the target cell in a RACH occasion in a subsequent PRACH slot responsive to the subsequent PDCCH order.

In an eleventh aspect, alone or in combination with one or more of the first through tenth aspects, the PDCCH order indicates a RACH occasion index associated with the RACH occasion and a preamble index associated with the PRACH.

In a twelfth aspect, alone or in combination with one or more of the first through eleventh aspects, process 900 includes communicating with the target cell as a new source cell responsive to receiving an RAR from the target cell during an RAR window.

In a thirteenth aspect, alone or in combination with one or more of the first through twelfth aspects, process 900 includes receiving, from the network node via the source cell prior to the MAC-CE triggering the handover to the target cell, an RRC configuration that indicates a set of PRACH parameters for the target cell, the PRACH transmitted according to the set of PRACH parameters indicated in the RRC configuration.

In a fourteenth aspect, alone or in combination with one or more of the first through thirteenth aspects, the set of PRACH parameters indicated in the RRC configuration includes one or more time-frequency resource parameters, one or more PRACH waveform parameters, and one or more power control parameters.

In a fifteenth aspect, alone or in combination with one or more of the first through fourteenth aspects, the MAC-CE triggering the handover from the source cell to the target cell indicates a TCI state associated with the target cell.

In a sixteenth aspect, alone or in combination with one or more of the first through fifteenth aspects, process 900 includes estimating a pathloss associated with the target cell in accordance with one or more measurements of a reference signal associated with the TCI state indicated in the MAC-CE, and transmitting the PRACH according to a PRACH transmission power, the PRACH transmission power identified in accordance with the estimated pathloss associated with the target cell and a parameter indicating a target received power level for the PRACH at the target cell.

In a seventeenth aspect, alone or in combination with one or more of the first through sixteenth aspects, process 900 includes applying power ramping to increase the PRACH transmission power in one or more successive PRACH slots responsive to an RAR not being received from the target cell during an RAR window.

In an eighteenth aspect, alone or in combination with one or more of the first through seventeenth aspects, process 900 includes transmitting, to the network node, UE capability information that indicates a minimum value for the slot offset indication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with aperiodic RACH procedure for LTM.

As shown in FIG. 10, in some aspects, process 1000 may include transmitting, to a UE via a source cell, a MAC-CE triggering a handover from the source cell to a target cell in an activated cell set configured for L1/L2 mobility (block 1010). For example, the network node (e.g., using transmission component 1204 and/or communication manager 1206, depicted in FIG. 12) may transmit, to a UE via a source cell, a MAC-CE triggering a handover from the source cell to a target cell in an activated cell set configured for L1/L2 mobility, as described above.

As further shown in FIG. 10, in some aspects, process 1000 may include receiving, from the UE via the target cell, a PRACH preamble to initiate an aperiodic CFRA procedure in the target cell in a RACH occasion in a PRACH slot that is associated with a slot offset indication (block 1020). For example, the network node (e.g., using reception component 1202 and/or communication manager 1206, depicted in FIG. 12) may receive, from the UE via the target cell, a PRACH preamble to initiate an aperiodic CFRA procedure in the target cell in a RACH occasion in a PRACH slot that is associated with a slot offset indication, as described above.

Process 1000 may include additional aspects, such as any single aspect or any combination of aspects described below and/or in connection with one or more other processes described elsewhere herein.

In a first aspect, the slot offset indication is included in the MAC-CE triggering the handover from the source cell to the target cell.

In a second aspect, alone or in combination with the first aspect, the MAC-CE triggering the handover from the source cell to the target cell indicates a RACH occasion index associated with the RACH occasion and a preamble index associated with the PRACH.

In a third aspect, alone or in combination with one or more of the first and second aspects, process 1000 includes receiving, from the UE via the source cell, HARQ feedback to acknowledge the MAC-CE triggering the handover, the slot offset indication being defined relative to an uplink message carrying the HARQ feedback and a processing delay associated with the MAC-CE.

In a fourth aspect, alone or in combination with one or more of the first through third aspects, process 1000 includes receiving, from the UE via the target cell, a retransmission of the PRACH preamble to initiate the aperiodic CFRA procedure in the target cell in a RACH occasion in a subsequent PRACH slot responsive to the MAC-CE configuring multiple PRACH opportunities.

In a fifth aspect, alone or in combination with one or more of the first through fourth aspects, an RAR window is configured to have a short duration responsive to the MAC-CE configuring multiple PRACH opportunities.

In a sixth aspect, alone or in combination with one or more of the first through fifth aspects, process 1000 includes transmitting, to the UE via the source cell, an RRC configuration that indicates a periodicity for the multiple PRACH opportunities and a number of PRACH opportunities.

In a seventh aspect, alone or in combination with one or more of the first through sixth aspects, process 1000 includes transmitting, to the UE via the target cell, a PDCCH order that includes a trigger for initiating the aperiodic CFRA procedure in the target cell, the slot offset indication being included in a DCI field in the PDCCH order.

In an eighth aspect, alone or in combination with one or more of the first through seventh aspects, process 1000 includes receiving, from the UE via the source cell, HARQ feedback to acknowledge the MAC-CE triggering the handover, the PDCCH order transmitted after a processing delay associated with the MAC-CE that is relative to an uplink message carrying the HARQ feedback.

In a ninth aspect, alone or in combination with one or more of the first through eighth aspects, the slot offset indication is defined relative to a slot in which the PDCCH order is received.

In a tenth aspect, alone or in combination with one or more of the first through ninth aspects, process 1000 includes transmitting, to the UE via the target cell, a subsequent PDCCH order that includes a trigger for initiating the aperiodic CFRA procedure in the target cell, and receiving, from the UE via the target cell, a retransmission of the PRACH preamble to initiate the aperiodic CFRA procedure in the target cell in a RACH occasion in a subsequent PRACH slot responsive to the subsequent PDCCH order.

In an eleventh aspect, alone or in combination with one or more of the first through tenth aspects, the PDCCH order indicates a RACH occasion index associated with the RACH occasion and a preamble index associated with the PRACH.

In a twelfth aspect, alone or in combination with one or more of the first through eleventh aspects, process 1000 includes communicating with the UE as a new source cell responsive to transmitting an RAR to the UE during an RAR window.

In a thirteenth aspect, alone or in combination with one or more of the first through twelfth aspects, process 1000 includes transmitting, to the UE via the source cell prior to the MAC-CE triggering the handover to the target cell, an RRC configuration that indicates a set of PRACH parameters for the target cell, the PRACH transmitted according to the set of PRACH parameters indicated in the RRC configuration.

In a fourteenth aspect, alone or in combination with one or more of the first through thirteenth aspects, the set of PRACH parameters indicated in the RRC configuration includes one or more time-frequency resource parameters, one or more PRACH waveform parameters, and one or more power control parameters.

In a fifteenth aspect, alone or in combination with one or more of the first through fourteenth aspects, the MAC-CE triggering the handover from the source cell to the target cell indicates a TCI state associated with the target cell.

In a sixteenth aspect, alone or in combination with one or more of the first through fifteenth aspects, process 1000 includes receiving, from the UE, UE capability information that indicates a minimum value for the slot offset indication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

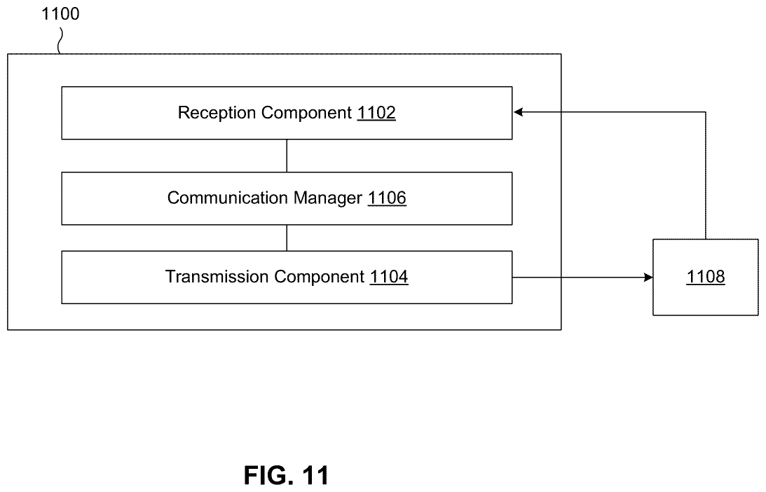

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7A-7B and/or FIGS. 8A-8B. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node via a source cell, a MAC-CE triggering a handover from the source cell to a target cell in an activated cell set configured for L1/L2 mobility. The transmission component 1104 may transmit, to the network node via the target cell, a PRACH preamble to initiate an aperiodic CFRA procedure in the target cell in a RACH occasion in a PRACH slot associated with a slot offset indication received from the network node.

The transmission component 1104 may transmit, to the network node via the source cell, HARQ feedback to acknowledge the MAC-CE triggering the handover, the slot offset indication defined relative to an uplink message carrying the HARQ feedback and a processing delay associated with the MAC-CE.

The transmission component 1104, responsive to a determination that a random access response (RAR) was not received from the target cell during an RAR window, may retransmit, to the network node via the target cell, the PRACH preamble to initiate the aperiodic CFRA procedure in the target cell in a RACH occasion in a subsequent PRACH slot responsive to the MAC-CE configuring multiple PRACH opportunities.

The reception component 1102 may receive, from the network node via the source cell, an RRC configuration that indicates a periodicity for the multiple PRACH opportunities and a number of PRACH opportunities.

The reception component 1102 may receive, from the network node via the target cell, a PDCCH order that includes a trigger for initiating the aperiodic CFRA procedure in the target cell, the slot offset indication included in a DCI field in the PDCCH order.

The transmission component 1104 may transmit, to the network node via the source cell, HARQ feedback to acknowledge the MAC-CE triggering the handover, the PDCCH order received after a processing delay associated with the MAC-CE that is defined relative to an uplink message carrying the HARQ feedback.

The reception component 1102 may receive, from the network node via the target cell, a subsequent PDCCH order that includes a trigger for initiating the aperiodic CFRA procedure in the target cell. The transmission component 1104 may retransmit, to the network node via the target cell, the PRACH preamble to initiate the aperiodic CFRA procedure in the target cell in a RACH occasion in a subsequent PRACH slot responsive to the subsequent PDCCH order.

The communication manager 1106 may communicate with the target cell as a new source cell responsive to receiving an RAR from the target cell during an RAR window.

The reception component 1102 may receive, from the network node via the source cell prior to the MAC-CE triggering the handover to the target cell, an RRC configuration that indicates a set of PRACH parameters for the target cell, the PRACH transmitted according to the set of PRACH parameters indicated in the RRC configuration.

The communication manager 1106 may estimate a pathloss associated with the target cell in accordance with one or more measurements of a reference signal associated with the TCI state indicated in the MAC-CE. The communication manager 1106 may determine a PRACH transmission power in accordance with the estimated pathloss associated with the target cell and a parameter indicating a target received power level for the PRACH at the target cell, the PRACH transmitted using the determined PRACH transmission power.

The communication manager 1106 may apply power ramping to increase the PRACH transmission power in one or more successive PRACH slots responsive to an RAR not being received from the target cell during an RAR window.

The transmission component 1104 may transmit, to the network node, UE capability information that indicates a minimum value for the slot offset indication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7A-7B and/or FIGS. 8A-8B. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE via a source cell, a MAC-CE triggering a handover from the source cell to a target cell in an activated cell set configured for L1/L2 mobility. The reception component 1202 may receive, from the UE via the target cell, a PRACH preamble to initiate an aperiodic CFRA procedure in the target cell in a RACH occasion in a PRACH slot that is associated with a slot offset indication.

The reception component 1202 may receive, from the UE via the source cell, HARQ feedback to acknowledge the MAC-CE triggering the handover, the slot offset indication being relative to an uplink message carrying the HARQ feedback and a processing delay associated with the MAC-CE.

The reception component 1202 may receive, from the UE via the target cell, a retransmission of the PRACH preamble to initiate the aperiodic CFRA procedure in the target cell in a RACH occasion in a subsequent PRACH slot responsive to the MAC-CE configuring multiple PRACH opportunities.

The transmission component 1204 may transmit, to the UE via the source cell, an RRC configuration that indicates a periodicity for the multiple PRACH opportunities and a number of PRACH opportunities.

The transmission component 1204 may transmit, to the UE via the target cell, a PDCCH order that includes a trigger for initiating the aperiodic CFRA procedure in the target cell, the slot offset indication being included in a DCI field in the PDCCH order.

The reception component 1202 may receive, from the UE via the source cell, HARQ feedback to acknowledge the MAC-CE triggering the handover, the PDCCH order transmitted after a processing delay associated with the MAC-CE that is relative to an uplink message carrying the HARQ feedback.

The transmission component 1204 may transmit, to the UE via the target cell, a subsequent PDCCH order that includes a trigger for initiating the aperiodic CFRA procedure in the target cell. The reception component 1202 may receive, from the UE via the target cell, a retransmission of the PRACH preamble to initiate the aperiodic CFRA procedure in the target cell in a RACH occasion in a subsequent PRACH slot responsive to the subsequent PDCCH order.

The communication manager 1206 may communicate with the UE as a new source cell responsive to transmitting an RAR to the UE during an RAR window.

The transmission component 1204 may transmit, to the UE via the source cell prior to the MAC-CE triggering the handover to the target cell, an RRC configuration that indicates a set of PRACH parameters for the target cell, the PRACH transmitted according to the set of PRACH parameters indicated in the RRC configuration.

The reception component 1202 may receive, from the UE, UE capability information that indicates a minimum value for the slot offset indication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed at a UE, comprising: receiving, from a network node via a source cell, a MAC-CE triggering a handover from the source cell to a target cell in an activated cell set configured for L1/L2 mobility; and transmitting, to the network node via the target cell, a PRACH preamble to initiate an aperiodic CFRA procedure in the target cell in a RACH occasion in a PRACH slot associated with a slot offset indication received from the network node.

Aspect 2: The method of Aspect 1, wherein the slot offset indication is included in the MAC-CE triggering the handover from the source cell to the target cell.

Aspect 3: The method of Aspect 2, wherein the MAC-CE triggering the handover from the source cell to the target cell indicates a RACH occasion index associated with the RACH occasion and a preamble index associated with the PRACH.

Aspect 4: The method of Aspect 2, further comprising: transmitting, to the network node via the source cell, HARQ feedback to acknowledge the MAC-CE triggering the handover, the slot offset indication being relative to an uplink message carrying the HARQ feedback and a processing delay associated with the MAC-CE.

Aspect 5: The method of Aspect 2, further comprising: responsive to a determination that an RAR was not received from the target cell during an RAR window, retransmitting, to the network node via the target cell, the PRACH preamble to initiate the aperiodic CFRA procedure in the target cell in a RACH occasion in a subsequent PRACH slot responsive to the MAC-CE configuring multiple PRACH opportunities.

Aspect 6: The method of Aspect 5, wherein the RAR window has a short duration responsive to the MAC-CE configuring multiple PRACH opportunities.

Aspect 7: The method of Aspect 5, further comprising: receiving, from the network node via the source cell, an RRC configuration that indicates a periodicity for the multiple PRACH opportunities and a number of PRACH opportunities.

Aspect 8: The method of any of Aspects 1-7, further comprising: receiving, from the network node via the target cell, a PDCCH order that includes a trigger for initiating the aperiodic CFRA procedure in the target cell, the slot offset indication included in a DCI field in the PDCCH order.

Aspect 9: The method of Aspect 8, further comprising: transmitting, to the network node via the source cell, HARQ feedback to acknowledge the MAC-CE triggering the handover, wherein the PDCCH order is received after a processing delay associated with the MAC-CE that is defined relative to an uplink message carrying the HARQ feedback.

Aspect 10: The method of Aspect 8, wherein the slot offset indication is defined relative to a slot in which the PDCCH order is received.

Aspect 11: The method of Aspect 8, further comprising: receiving, from the network node via the target cell, a subsequent PDCCH order that includes a trigger for initiating the aperiodic CFRA procedure in the target cell; and retransmitting, to the network node via the target cell, the PRACH preamble to initiate the aperiodic CFRA procedure in the target cell in a RACH occasion in a subsequent PRACH slot responsive to the subsequent PDCCH order.

Aspect 12: The method of Aspect 8, wherein the PDCCH order indicates a RACH occasion index associated with the RACH occasion and a preamble index associated with the PRACH.

Aspect 13: The method of any of Aspects 1-12, further comprising: communicating with the target cell as a new source cell responsive to receiving an RAR from the target cell during an RAR window.

Aspect 14: The method of any of Aspects 1-13, further comprising: receiving, from the network node via the source cell prior to the MAC-CE triggering the handover to the target cell, an RRC configuration that indicates a set of PRACH parameters for the target cell, the PRACH transmitted according to the set of PRACH parameters indicated in the RRC configuration.

Aspect 15: The method of Aspect 14, wherein the set of PRACH parameters indicated in the RRC configuration includes one or more time-frequency resource parameters, one or more PRACH waveform parameters, and one or more power control parameters.

Aspect 16: The method of any of Aspects 1-15, wherein the MAC-CE triggering the handover from the source cell to the target cell indicates a TCI state associated with the target cell.

Aspect 17: The method of Aspect 16, further comprising: estimating a pathloss associated with the target cell in accordance with one or more measurements of a reference signal associated with the TCI state indicated in the MAC-CE; and transmitting the PRACH according to a PRACH transmission power, the PRACH transmission power identified in accordance with the estimated pathloss associated with the target cell and a parameter indicating a target received power level for the PRACH at the target cell.

Aspect 18: The method of Aspect 17, further comprising: applying power ramping to increase the PRACH transmission power in one or more successive PRACH slots responsive to an RAR not being received from the target cell during an RAR window.

Aspect 19: The method of any of Aspects 1-18, further comprising: transmitting, to the network node, UE capability information that indicates a minimum value for the slot offset indication.

Aspect 20: A method of wireless communication performed at a network node, comprising: transmitting, to a UE via a source cell, a MAC-CE triggering a handover from the source cell to a target cell in an activated cell set configured for L1/L2 mobility; and receiving, from the UE via the target cell, a PRACH preamble to initiate an aperiodic CFRA procedure in the target cell in a RACH occasion in a PRACH slot that is associated with a slot offset indication.

Aspect 21: The method of Aspect 20, wherein the slot offset indication is included in the MAC-CE triggering the handover from the source cell to the target cell.

Aspect 22: The method of Aspect 21, wherein the MAC-CE triggering the handover from the source cell to the target cell indicates a RACH occasion index associated with the RACH occasion and a preamble index associated with the PRACH.

Aspect 23: The method of Aspect 21, further comprising: receiving, from the UE via the source cell, HARQ feedback to acknowledge the MAC-CE triggering the handover, the slot offset indication being relative to an uplink message carrying the HARQ feedback and a processing delay associated with the MAC-CE.

Aspect 24: The method of Aspect 21, further comprising: receiving, from the UE via the target cell, a retransmission of the PRACH preamble to initiate the aperiodic CFRA procedure in the target cell in a RACH occasion in a subsequent PRACH slot responsive to the MAC-CE configuring multiple PRACH opportunities.

Aspect 25: The method of Aspect 24, wherein an RAR window is configured to have a short duration responsive to the MAC-CE configuring multiple PRACH opportunities.

Aspect 26: The method of Aspect 24, further comprising: transmitting, to the UE via the source cell, an RRC configuration that indicates a periodicity for the multiple PRACH opportunities and a number of PRACH opportunities.

Aspect 27: The method of any of Aspects 20-26, further comprising: transmitting, to the UE via the target cell, a PDCCH order that includes a trigger for initiating the aperiodic CFRA procedure in the target cell, the slot offset indication being included in a DCI field in the PDCCH order.

Aspect 28: The method of Aspect 27, further comprising: receiving, from the UE via the source cell, HARQ feedback to acknowledge the MAC-CE triggering the handover, the PDCCH order transmitted after a processing delay associated with the MAC-CE that is relative to an uplink message carrying the HARQ feedback.

Aspect 29: The method of Aspect 27, wherein the slot offset indication is defined relative to a slot in which the PDCCH order is received.

Aspect 30: The method of Aspect 27, further comprising: transmitting, to the UE via the target cell, a subsequent PDCCH order that includes a trigger for initiating the aperiodic CFRA procedure in the target cell; and receiving, from the UE via the target cell, a retransmission of the PRACH preamble to initiate the aperiodic CFRA procedure in the target cell in a RACH occasion in a subsequent PRACH slot responsive to the subsequent PDCCH order.

Aspect 31: The method of Aspect 27, wherein the PDCCH order indicates a RACH occasion index associated with the RACH occasion and a preamble index associated with the PRACH.

Aspect 32: The method of any of Aspects 20-31, further comprising: communicating with the UE as a new source cell responsive to transmitting an RAR to the UE during an RAR window.

Aspect 33: The method of any of Aspects 20-32, further comprising: transmitting, to the UE via the source cell prior to the MAC-CE triggering the handover to the target cell, an RRC configuration that indicates a set of PRACH parameters for the target cell, the PRACH transmitted according to the set of PRACH parameters indicated in the RRC configuration.

Aspect 34: The method of Aspect 33, wherein the set of PRACH parameters indicated in the RRC configuration includes one or more time-frequency resource parameters, one or more PRACH waveform parameters, and one or more power control parameters.

Aspect 35: The method of any of Aspects 20-34, wherein the MAC-CE triggering the handover from the source cell to the target cell indicates a TCI state associated with the target cell.

Aspect 36: The method of any of Aspects 20-35, further comprising: receiving, from the UE, UE capability information that indicates a minimum value for the slot offset indication.

Aspect 37: An apparatus for wireless communication at a device, comprising a processor; memory coupled with the processor; and instructions stored in the memory and executable by the processor to cause the apparatus to perform the method of one or more of Aspects 1-36.

Aspect 38: A device for wireless communication, comprising a memory and one or more processors coupled to the memory, the one or more processors configured to perform the method of one or more of Aspects 1-36.

Aspect 39: An apparatus for wireless communication, comprising at least one means for performing the method of one or more of Aspects 1-36.

Aspect 40: A non-transitory computer-readable medium storing code for wireless communication, the code comprising instructions executable by a processor to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

Aspect 42: An apparatus for wireless communication at a device, comprising one or more memories storing processor-executable code; and one or more processors coupled with the one or more memories, at least one processor of the one or more processors configured to cause the device to perform the method of one or more of Aspects 1-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive, from a network node via a source cell, a medium access control (MAC) control element (MAC-CE) triggering a handover from the source cell to a target cell in an activated cell set configured for Layer 1/Layer 2 (L1/L2) mobility; and
transmit, to the network node via the target cell, a physical random access channel (PRACH) to initiate an aperiodic contention-free random access (CFRA) procedure in the target cell in a random access channel (RACH) occasion in a PRACH slot associated with a slot offset indication received from the network node.

2. The apparatus of claim 1, wherein the slot offset indication is included in the MAC-CE triggering the handover from the source cell to the target cell.

3. The apparatus of claim 2, wherein the MAC-CE triggering the handover from the source cell to the target cell indicates a RACH occasion index associated with the RACH occasion and a preamble index associated with the PRACH.

4. The apparatus of claim 2, wherein the at least one processor of the one or more processors is further configured to cause the UE to:
transmit, to the network node via the source cell, hybrid automatic repeat request (HARQ) feedback to acknowledge the MAC-CE triggering the handover, the slot offset indication being relative to an uplink message carrying the HARQ feedback and a processing delay associated with the MAC-CE.

5. The apparatus of claim 2, wherein the at least one processor of the one or more processors is further configured to cause the UE to:
responsive to a determination that a random access response (RAR) was not received from the target cell during an RAR window,
retransmit, to the network node via the target cell, the PRACH preamble to initiate the aperiodic CFRA procedure in the target cell in a RACH occasion in a subsequent PRACH slot responsive to the MAC-CE configuring multiple PRACH opportunities.

6. The apparatus of claim 5, wherein the RAR window has a short duration responsive to the MAC-CE configuring multiple PRACH opportunities.

7. The apparatus of claim 5, wherein the at least one processor of the one or more processors is further configured to cause the UE to:
receive, from the network node via the source cell, a radio resource control (RRC) configuration that indicates a periodicity for the multiple PRACH opportunities and a number of PRACH opportunities.

8. The apparatus of claim 1, wherein the at least one processor of the one or more processors is further configured to cause the UE to:
receive, from the network node via the target cell, a physical downlink control channel (PDCCH) order that includes a trigger for initiating the aperiodic CFRA procedure in the target cell, the slot offset indication included in a downlink control information (DCI) field in the PDCCH order.

9. The apparatus of claim 8, wherein the at least one processor of the one or more processors is further configured to cause the UE to:
transmit, to the network node via the source cell, hybrid automatic repeat request (HARQ) feedback to acknowledge the MAC-CE triggering the handover, wherein the PDCCH order is received after a processing delay associated with the MAC-CE that is defined relative to an uplink message carrying the HARQ feedback.

10. The apparatus of claim 8, wherein the slot offset indication is defined relative to a slot in which the PDCCH order is received.

11. The apparatus of claim 8, wherein the PDCCH order indicates a RACH occasion index associated with the RACH occasion and a preamble index associated with the PRACH.

12. The apparatus of claim 1, wherein the at least one processor of the one or more processors is further configured to cause the UE to:
receive, from the network node via the source cell prior to the MAC-CE triggering the handover to the target cell, a radio resource control (RRC) configuration that indicates a set of PRACH parameters for the target cell, the PRACH transmitted according to the set of PRACH parameters indicated in the RRC configuration.

13. The apparatus of claim 1, wherein the MAC-CE triggering the handover from the source cell to the target cell indicates a transmission configuration indication (TCI) state associated with the target cell.

14. The apparatus of claim 1, wherein the at least one processor of the one or more processors is further configured to cause the UE to:
transmit, to the network node, UE capability information that indicates a minimum value for the slot offset indication.

15. An apparatus for wireless communication at a network node, comprising:
one or more memories storing processor-executable code; and
one or more processors coupled with the one or more memories, at least one processor of the one or more processors configured to cause the network node to:
transmit, to a user equipment (UE) via a source cell, a medium access control (MAC) control element (MAC-CE) triggering a handover from the source cell to a target cell in an activated cell set configured for Layer 1/Layer 2 (L1/L2) mobility; and
receive, from the UE via the target cell, a physical random access channel (PRACH) to initiate an aperiodic contention-free random access (CFRA) procedure in the target cell in a random access channel (RACH) occasion in a PRACH slot that is associated with a slot offset indication.

16. The apparatus of claim 15, wherein the slot offset indication is included in the MAC-CE triggering the handover from the source cell to the target cell.

17. The apparatus of claim 16, wherein the MAC-CE triggering the handover from the source cell to the target cell indicates a RACH occasion index associated with the RACH occasion and a preamble index associated with the PRACH.

18. The apparatus of claim 16, wherein the at least one processor of the one or more processors is further configured to cause the network node to:
receive, from the UE via the source cell, hybrid automatic repeat request (HARQ) feedback to acknowledge the MAC-CE triggering the handover, the slot offset indication being relative to an uplink message carrying the HARQ feedback and a processing delay associated with the MAC-CE.

19. The apparatus of claim 16, wherein the at least one processor of the one or more processors is further configured to cause the network node to:
receive, from the UE via the target cell, a retransmission of the PRACH preamble to initiate the aperiodic CFRA procedure in the target cell in a RACH occasion in a subsequent PRACH slot responsive to the MAC-CE configuring multiple PRACH opportunities.

20. The apparatus of claim 19, wherein a random access response (RAR) window is configured to have a short duration responsive to the MAC-CE configuring multiple PRACH opportunities.

21. The apparatus of claim 19, wherein the at least one processor of the one or more processors is further configured to cause the network node to:
transmit, to the UE via the source cell, a radio resource control (RRC) configuration that indicates a periodicity for the multiple PRACH opportunities and a number of PRACH opportunities.

22. The apparatus of claim 15, wherein the at least one processor of the one or more processors is further configured to cause the network node to:
transmit, to the UE via the target cell, a physical downlink control channel (PDCCH) order that includes a trigger for initiating the aperiodic CFRA procedure in the target cell, the slot offset indication being included in a downlink control information (DCI) field in the PDCCH order.

23. The apparatus of claim 22, wherein the at least one processor of the one or more processors is further configured to cause the network node to:
receive, from the UE via the source cell, hybrid automatic repeat request (HARQ) feedback to acknowledge the MAC-CE triggering the handover, the PDCCH order transmitted after a processing delay associated with the MAC-CE that is relative to an uplink message carrying the HARQ feedback.

24. The apparatus of claim 22, wherein the slot offset indication is defined relative to a slot in which the PDCCH order is received.

25. The apparatus of claim 22, wherein the PDCCH order indicates a RACH occasion index associated with the RACH occasion and a preamble index associated with the PRACH.

26. The apparatus of claim 15, wherein the at least one processor of the one or more processors is further configured to cause the network node to:
transmit, to the UE via the source cell prior to the MAC-CE triggering the handover to the target cell, a radio resource control (RRC) configuration that indicates a set of PRACH parameters for the target cell, the PRACH transmitted according to the set of PRACH parameters indicated in the RRC configuration.

27. The apparatus of claim 15, wherein the MAC-CE triggering the handover from the source cell to the target cell indicates a transmission configuration indication (TCI) state associated with the target cell.

28. The apparatus of claim 15, wherein the at least one processor of the one or more processors is further configured to cause the network node to:
receive, from the UE, UE capability information that indicates a minimum value for the slot offset indication.

29. A method of wireless communication performed at a user equipment (UE), comprising:
receiving, from a network node via a source cell, a medium access control (MAC) control element (MAC-CE) triggering a handover from the source cell to a target cell in an activated cell set configured for Layer 1/Layer 2 (L1/L2) mobility; and
transmitting, to the network node via the target cell, a physical random access channel (PRACH) to initiate an aperiodic contention-free random access (CFRA) procedure in the target cell in a random access channel (RACH) occasion in a PRACH slot associated with a slot offset indication received from the network node.

30. A method of wireless communication performed at a network node, comprising:
transmitting, to a user equipment (UE) via a source cell, a medium access control (MAC) control element (MAC-CE) triggering a handover from the source cell to a target cell in an activated cell set configured for Layer 1/Layer 2 (L1/L2) mobility; and
receiving, from the UE via the target cell, a physical random access channel (PRACH) to initiate an aperiodic contention-free random access (CFRA) procedure in the target cell in a random access channel (RACH) occasion in a PRACH slot that is associated with a slot offset indication.
